(19) United States
(12) Patent Application Publication
(10) Pub. No.: US 2017/0206616 A1
(43) Pub. Date: Jul. 20, 2017

(54) SYSTEM AND METHOD OF PROVIDING HYBRID INNOVATION AND LEARNING MANAGEMENT

(71) Applicants: Salar Chagpar, Mississauga (CA); Caitlin E. McDonough, Toronto (CA)

(72) Inventors: Salar Chagpar, Mississauga (CA); Caitlin E. McDonough, Toronto (CA)

(21) Appl. No.: 15/000,004

(22) Filed: Jan. 18, 2016

(51) Int. Cl. G06Q 50/20; G06F 17/30; G06N 5/04

(52) U.S. Cl. CPC G06Q 50/20; G06N 5/04; G06F 17/3087

(57) ABSTRACT

Systems and methods are disclosed for providing hybrid innovation and learning management. In one aspect, a method includes storing, on a storage device, a plurality of user profiles, a plurality of projects, and a plurality of pre-defined project statuses. The method further involves maintaining project information for each project; maintaining user information for each user profile; updating master proximity factors based on the plurality of user profiles and the plurality of project information. The method further involves determining an overall viability for a first project based on project information of the first project, user profiles associated with the first project, and master proximity factors; recommending project tasks for the first project based on the determined overall viability; and recommending learning actions for a first user profile associated with the first project based on the first user profile and master proximity factors.

### FIELD

The present disclosure relates to the fields of innovation management and learning management.

### INTRODUCTION

Projects are often started in a classroom, in a business unit, in an existing project team, or at entrepreneurship, venture, or innovation focused events. Such events include hackathons, innovation challenges, business plan competitions and startup events. These projects often encounter problems with attrition, scale, efficiency or growth due to a mis-configured team or product-market mismatch. After an initial project start, the project loses momentum after the team leaves the event. As well, participation in such projects is limited to event attendees. However, the participation of some individuals that have not attended the event may be valuable to the project. Furthermore, when individuals come up with ideas for projects outside of such events, they may not have easily accessible resources and networks to start the projects. Additionally, they may not be able to successfully complete them due to project constraints, such as lack of advisory or education.

In addition, project team members are critical to the success of a project. Amongst other things, project team members require skills and knowledge to execute the project. The development of skills and knowledge is an ongoing process and may occur in parallel with team members' participation in a project. Furthermore, project team members may develop skills and knowledge from the execution of the project.

### SUMMARY

In accordance with at least one embodiment of the invention, there is provided a computer-implemented method for providing hybrid innovation and learning management. The method involves in a system configured to host a webpage, the system including at least one processor and a memory, storing, on a storage device, a plurality of user profiles, a plurality of projects, and a plurality of pre-defined project statuses, each project being associated with at least one user profile, each user profile including user information received from a client device linked to that user profile, each project including project information received from a client device linked to a user profile associated with that project, project information including at least one project status indicator corresponding to a pre-defined project status; maintaining, on the storage device, project information for each project; maintaining, on the storage device, user information for each user profile; updating master proximity factors based on the plurality of user profiles and the plurality of project information; determining an overall viability for a first project based on project information of the first project, user profiles associated with the first project, and master proximity factors; recommending project tasks for the first project based on the determined overall viability; recommending learning actions for a first user profile associated with the first project based on the first user profile and master proximity factors and optionally, projects associated with the first user profile; and displaying, on a graphical user interface for a client device linked to the first user profile, recommended learning actions for the first user profile and recommended project tasks for projects associated with the first user profile.

In at least one embodiment, the step of recommending learning actions for a first user profile associated with the first project further includes recommending learning actions based on the overall viability for the first project.

In at least one embodiment, the step of updating master proximity factors includes: storing, on the storage device, master proximity factors; and for each project, assessing project performance based on the project information for that project; determining project proximity factors based on the project performance and the project information for that project; updating the master proximity factors based on project proximity factors for that project; and for each user profile associated with that project, assessing user development based on user information for that user profile; determining user proximity factors based on the user development and the user information; and updating the master proximity factors based on the user proximity factors.

In at least one embodiment, the step of recommending project tasks for the first project includes: determining current project proximities that are non-compliant with master proximity factors; identifying project tasks that improve non-compliant current project proximities; and determining whether identified project tasks are applicable to the first project.

In at least one embodiment, the step of recommending learning actions for a first user profile associated with the first project includes: determining current user proximities that are non-compliant with master proximity factors; identifying learning actions that improve non-compliant current user proximities; and determining whether identified learning actions are applicable to the first user profile.

In accordance with an embodiment of the invention, there is provided a non-transitory computer-readable storage medium having instructions stored thereon for execution by one or more processors for implementing a method involving storing, on a storage device, a plurality of user profiles, a plurality of projects, and a plurality of pre-defined project statuses, each project being associated with at least one user profile, each user profile comprising user information received from a client device linked to that user profile, each project comprising project information received from a client device linked to a user profile associated with that project, project information comprising at least one project status indicator corresponding to a pre-defined project status; maintaining, on the storage device, project information for each project; maintaining, on the storage device, user information for each user profile; updating master proximity factors based on the plurality of user profiles and the plurality of project information; determining an overall viability for a first project based on project information of the first project, user profiles associated with the first project, and master proximity factors; recommending project tasks for the first project based on the determined overall viability; recommending learning actions for a first user profile associated with the first project based on the first user profile and master proximity factors and optionally, projects associated with the first user profile; and displaying, on a graphical user interface for a client device linked to the first user profile, recommended learning actions for the first user profile and recommended project tasks for projects associated with the first user profile.

### DRAWINGS

For a better understanding of the embodiments described herein and to show more clearly how they may be carried into effect, reference will now be made, by way of example only, to the accompanying drawings which show at least one exemplary embodiment, and in which:

FIG. 1 shows a block diagram illustrating a system for providing hybrid innovation and learning management, in accordance with at least one embodiment;

FIG. 2 shows a block diagram illustrating functions of a system for providing innovation and learning management, in accordance with at least one embodiment;

FIG. 3-A shows a line diagram illustrating information related to a user profile, in accordance with at least one embodiment;

FIG. 3-B shows a line diagram illustrating information related to a project, in accordance with at least one embodiment;

FIG. 3-C shows a line diagram illustrating information related to the interaction of a user with projects, in accordance with at least one embodiment;

FIG. 3-D shows a line diagram illustrating information related to feedback, in accordance with at least one embodiment;

FIG. 3-E shows a line diagram illustrating information related to events, in accordance with at least one embodiment;

FIG. 3-F shows a line diagram illustrating information related to learning resources, in accordance with at least one embodiment;

FIG. 3-G shows a line diagram illustrating information related to badges, in accordance with at least one embodiment;

FIG. 4-A shows a block diagram illustrating a network structure of the system, in accordance with at least one embodiment;

FIG. 4-B shows a block diagram illustrating the relationship between an organization and modules, in accordance with at least one embodiment;

FIG. 4-C shows a block diagram illustrating the relationship between sub-organizations and modules, in accordance with at least one embodiment;

FIG. 4-D shows a block diagram illustrating the relationship between sub-organizations and locations of client devices, in accordance with at least one embodiment;

FIG. 5 shows a flowchart illustrating a method of providing hybrid innovation and learning management, in accordance with at least one embodiment;

FIG. 6-A shows a block diagram illustrating the structure of the intelligence machine for updating the master proximity factors, in accordance with at least one embodiment;

FIG. 6-B shows a block diagram illustrating the structure of the intelligence machine for determining an overall viability for a project, in accordance with at least one embodiment;

FIG. 6-C shows a block diagram illustrating the structure of the intelligence machine for recommending project tasks and learning actions, in accordance with at least one embodiment;

FIG. 7-A shows a user profile page, in accordance with at least one embodiment;

FIG. 7-B shows a group profile page, in accordance with at least one embodiment;

FIG. 7-C shows a project profile page, in accordance with at least one embodiment;

FIG. 7-D shows a second project profile page illustrating project content, in accordance with at least one embodiment;

FIG. 7-E shows a first explorer feed illustrating primary and secondary project statuses, in accordance with at least one embodiment;

FIG. 7-F shows a file submission and feedback page, in accordance with at least one embodiment;

FIG. 7-G shows an event profile page, in accordance with at least one embodiment;

FIGS. 7-H to 7-J show learning resource profile pages, in accordance with at least one embodiment;

FIG. 7-K shows a learning resource group profile page, in accordance with at least one embodiment;

FIG. 7-L shows a badge profile page, in accordance with at least one embodiment;

FIG. 7-M shows a project creation page, in accordance with at least one embodiment;

FIG. 7-N shows a project team creation page, in accordance with at least one embodiment; and

FIG. 7-O shows a project explorer feed, in accordance with at least one embodiment.

The skilled person in the art will understand that the drawings, described below, are for illustration purposes only. The drawings are not intended to limit the scope of the applicants' teachings in anyway. Also, it will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DESCRIPTION OF VARIOUS EMBODIMENTS

Numerous embodiments are described in this application, and are presented for illustrative purposes only. The described embodiments are not intended to be limiting in any sense. The invention is widely applicable to numerous embodiments, as is readily apparent from the disclosure herein. Those skilled in the art will recognize that the present invention may be practiced with modification and alteration without departing from the teachings disclosed herein. Although particular features of the present invention may be described with reference to one or more particular embodiments or figures, it should be understood that such features are not limited to usage in the one or more particular embodiments or figures with reference to which they are described.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

The terms “an embodiment,” “embodiment,” “embodiments,” “the embodiment,” “the embodiments,” “one or more embodiments,” “some embodiments,” and “one embodiment” mean “one or more (but not all) embodiments of the present invention(s),” unless expressly specified otherwise.

The terms “including,” “comprising” and variations thereof mean “including but not limited to,” unless expressly specified otherwise. A listing of items does not imply that any or all of the items are mutually exclusive, unless expressly specified otherwise. The terms “a,” “an” and “the” mean “one or more,” unless expressly specified otherwise.

A description of an embodiment with several components in communication with each other does not imply that all such components are required. On the contrary a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The various embodiments described herein generally relate to methods (and associated systems configured to implement methods) for providing a social network to facilitate sustainable development of innovative projects and manage learning by individuals.

Users may create profiles for themselves in the system. User profiles may include but are not limited to psychometrics, demographics, socio-economics, education, health, interests, hobbies, and locations.

The system may enable users to create projects. Projects may be created by providing information such as a project name, project description, and project keywords. The system may enable users to join existing projects; the plurality of users that have joined a project may be referred to as a project team or project group. Once a project is created in the system, the development of the project, such as milestones, may be tracked within the system. The system may also enable users to provide feedback about projects and users. The system may rank feedback that a user contributes to a particular project based on the success of the user's past projects and past feedback on other projects.

The system may also enable users to create challenges. Challenges may be created by providing information such as a focus area, industry, or sector. The system may enable projects to be created in response to challenges. Alternatively, existing projects may also respond to new challenges. That is, the relationship between projects and challenges are not causal.

The system may also provide learning resources to users. The learning resources may be interactive learning modules. The learning resources may cover a variety of topics including, but not limited to, entrepreneurship, project management, innovation, and science, technology, engineering, and mathematics (STEM) topics. The learning resources may include, but are not limited to reading material, videos, assignments, workbooks, quizzes, and tests. Learning resources may be provided via ad-hoc push learning, such as e-mails or application notifications. Learning resources may be provided based on project statuses of a project that a user may be associated with. In one example, learning resources may be provided upon completion of project statuses. In a second example, learning resources may be provided based on a critical path for project statuses. Learning resources may also be provided on learner-directed basis. An example of a learner-directed basis may be a summary list view with options to dismiss items.

The system may also enable users to organize or participate in events and workshops. Such events and workshops may also serve as learning resources for users, providing skills and knowledge development. The system may also enable users to create organization profiles for an organization that they are associated with in the system.

The system may monitor user engagement such as project participation, feedback contribution, learning achievements, and event or workshop attendance. The system may analyze monitored data to evaluate projects and users, particularly users' learning trajectories, and make recommendations for project development. The metrics may also be used to evaluate users and make recommendations for personal development. Such evaluation and recommendations may be provided by the system on an ongoing basis to improve projects and user skill and knowledge development. The recommendations for projects may include, but are not limited to, suggesting challenge problems, suggesting milestones and tasks, suggesting members, mentors, advisors, experts, and suggesting learning modules, educational resources, events and workshops to project team members. The recommendations for users may include, but are not limited to, suggesting learning modules, challenge problems, educational resources, projects, events and workshops. The recommendations for users may be based on user profile data.

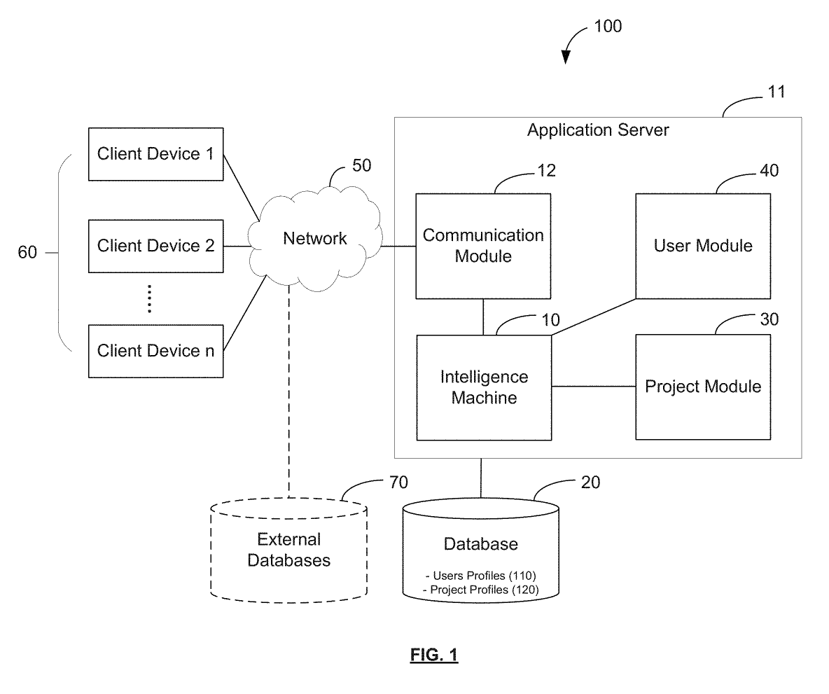

FIG. 1 is a block diagram illustrating an exemplary embodiment of a system for providing hybrid innovation and learning management, referred to generally as 100. The system 100 may include an application server 11 and an electronic database 20. The application server 11 may include a communication module 12 and at least one processor with memory and instructions. The application server 11 may include an intelligence machine 10, a project module 30, and a user module 40.

Generally, users at client devices 60 can communicate with the application server 11 across network 50 to create user profiles 110 for themselves. The application server 11 may receive the user profiles 22 and store the user profiles 22 in the electronic database 20. Users at client devices 60 can also communicate with the application server 11 to create projects 120 which the application server 11 may also store in the electronic database 20. The application server 11 may also access external databases 70 across network 50. Generally, external databases 70 are external to the system 100 and maintained by third-parties. External databases 70 may include databases, websites, servers, or other similar sources of electronic information.

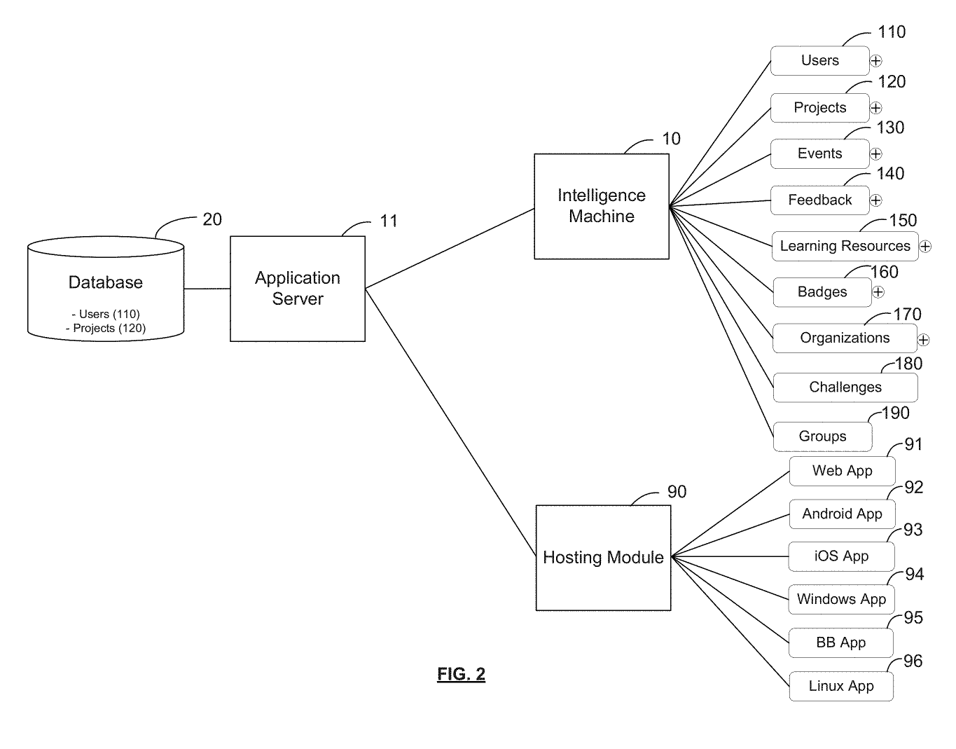

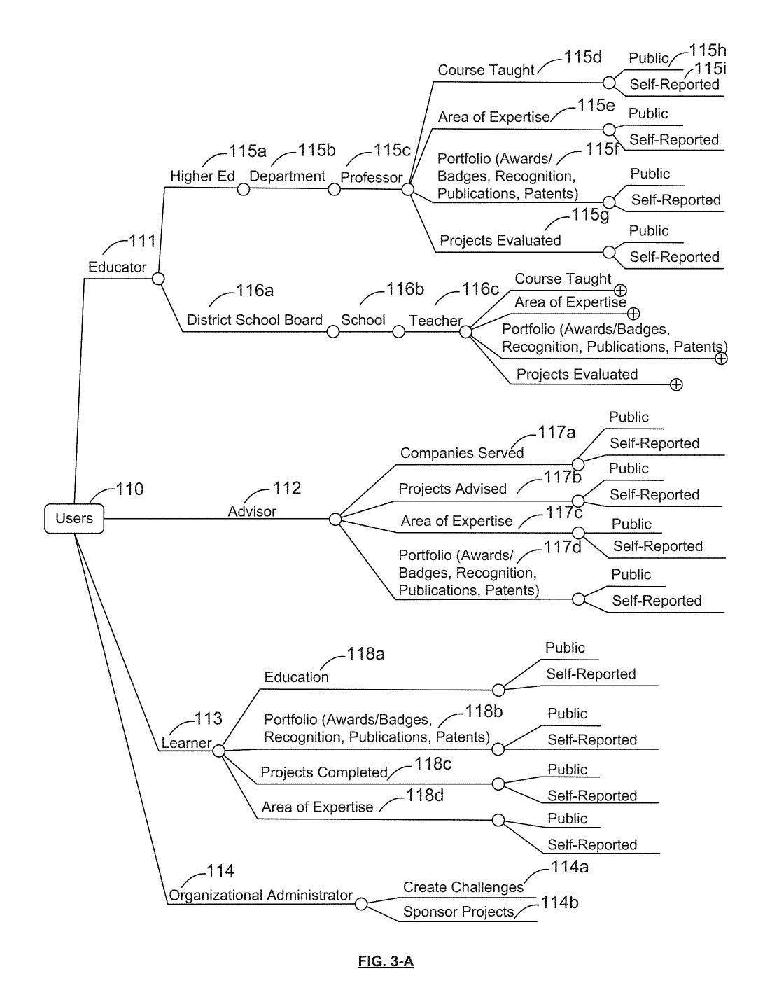

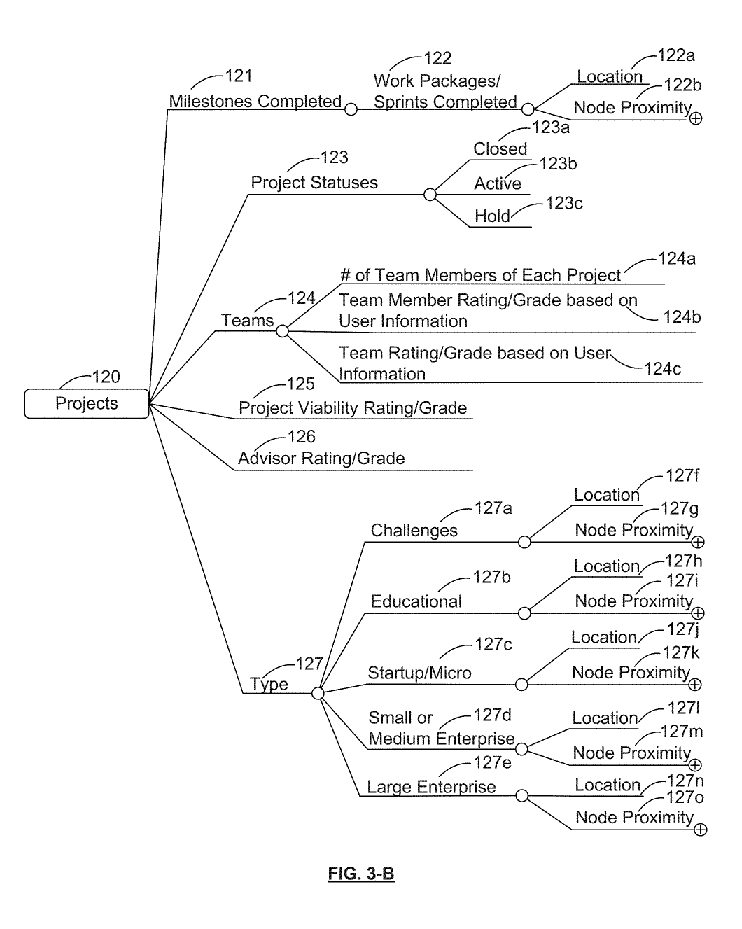

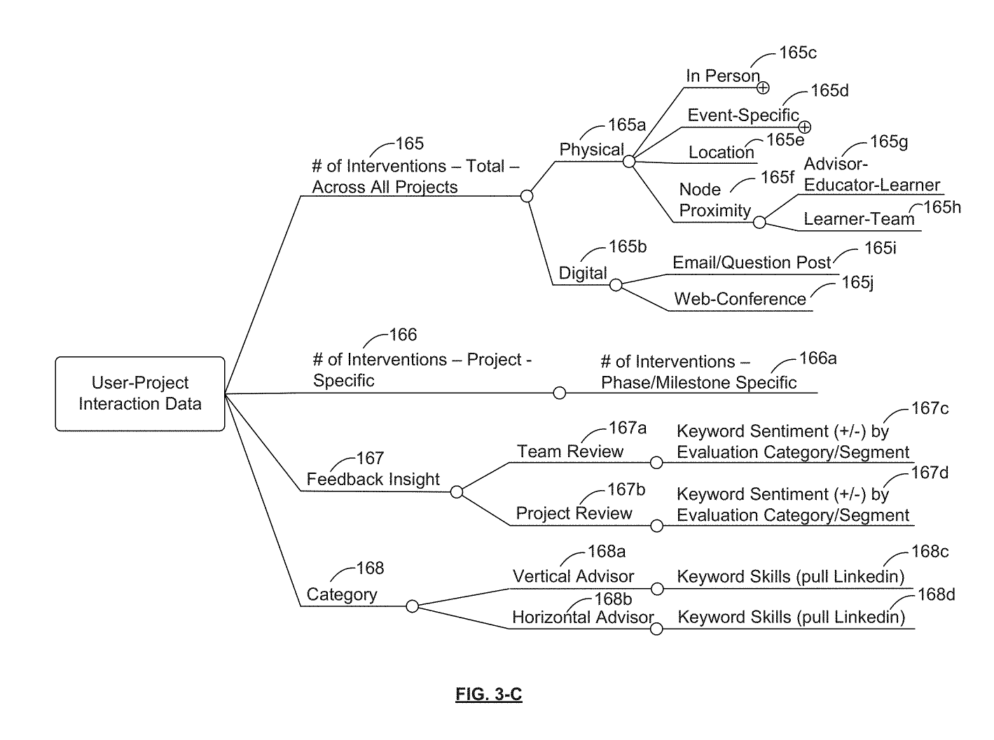

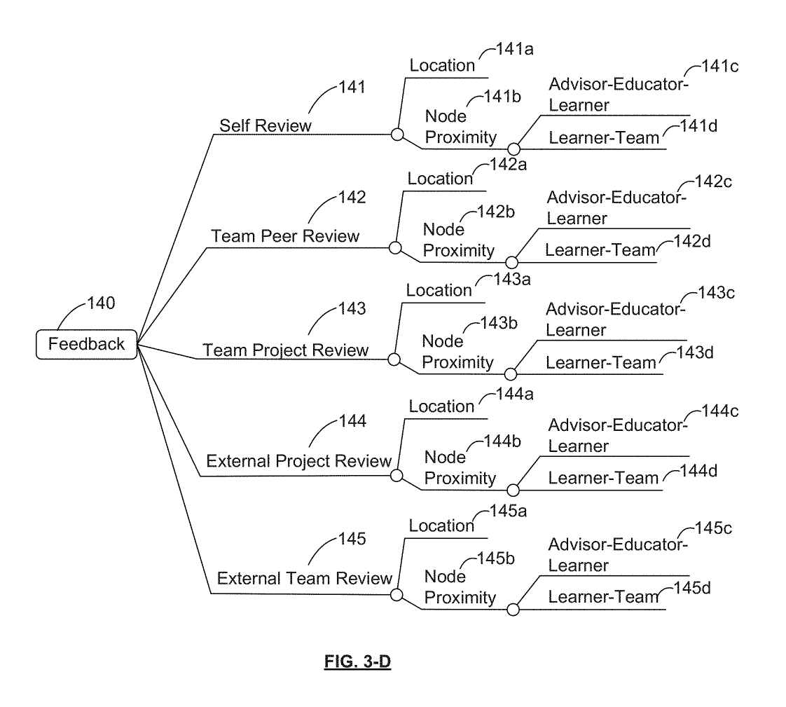

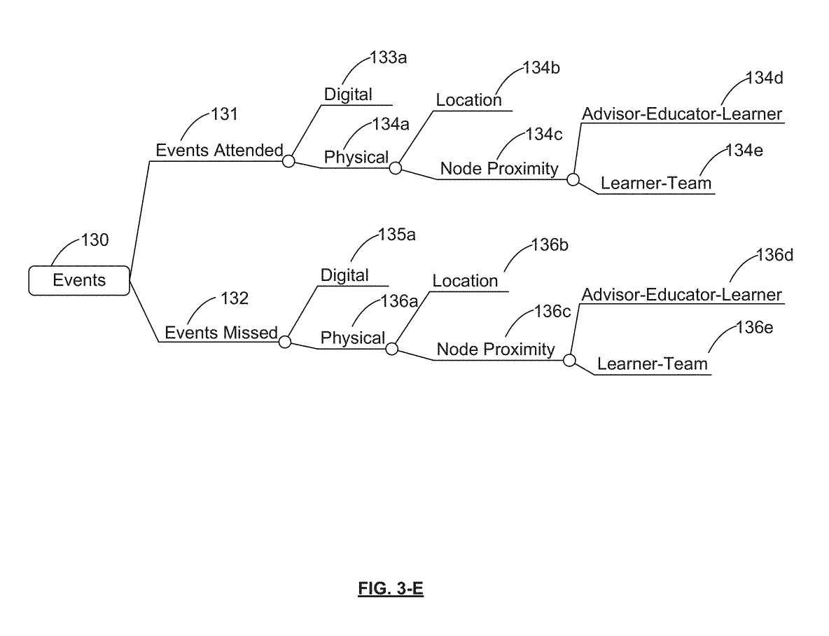

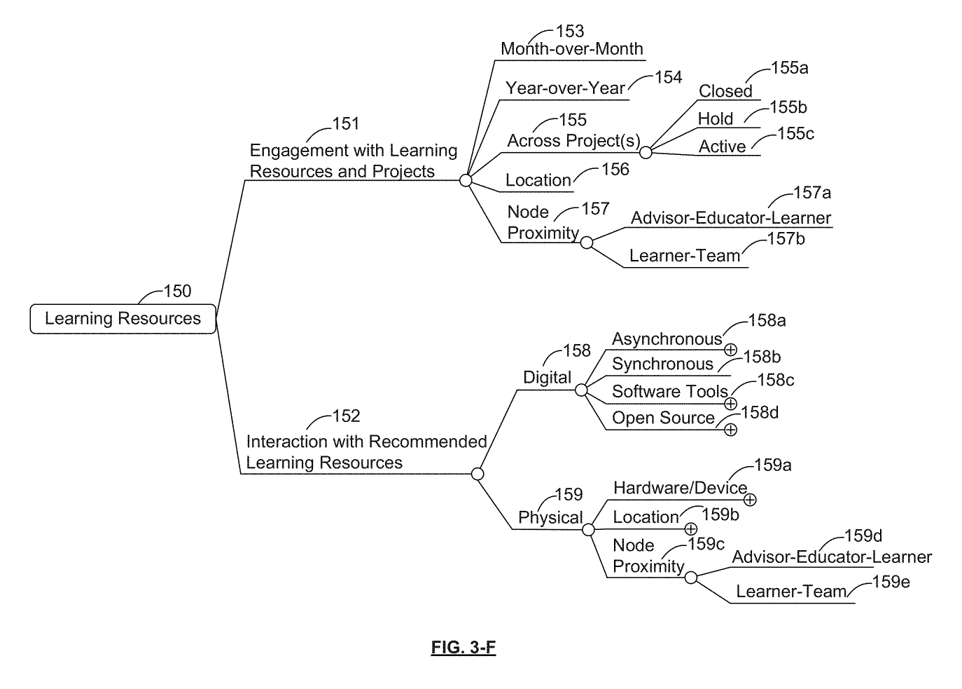

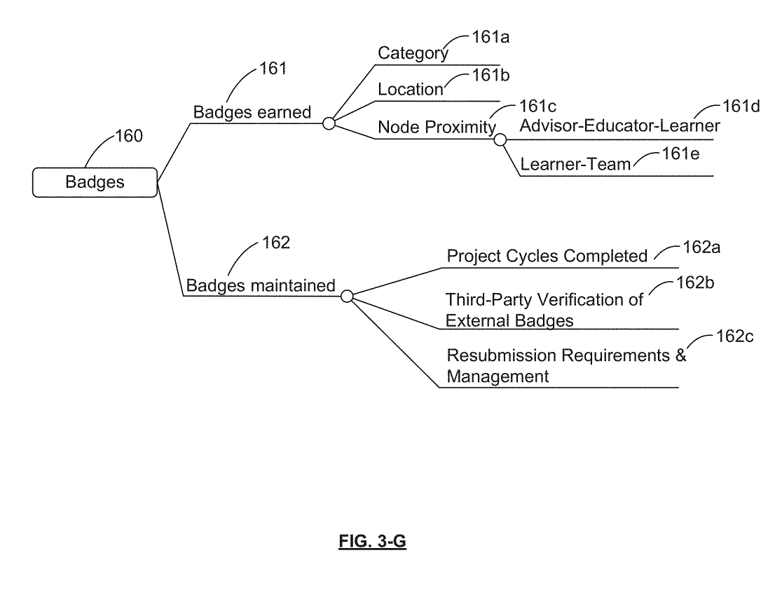

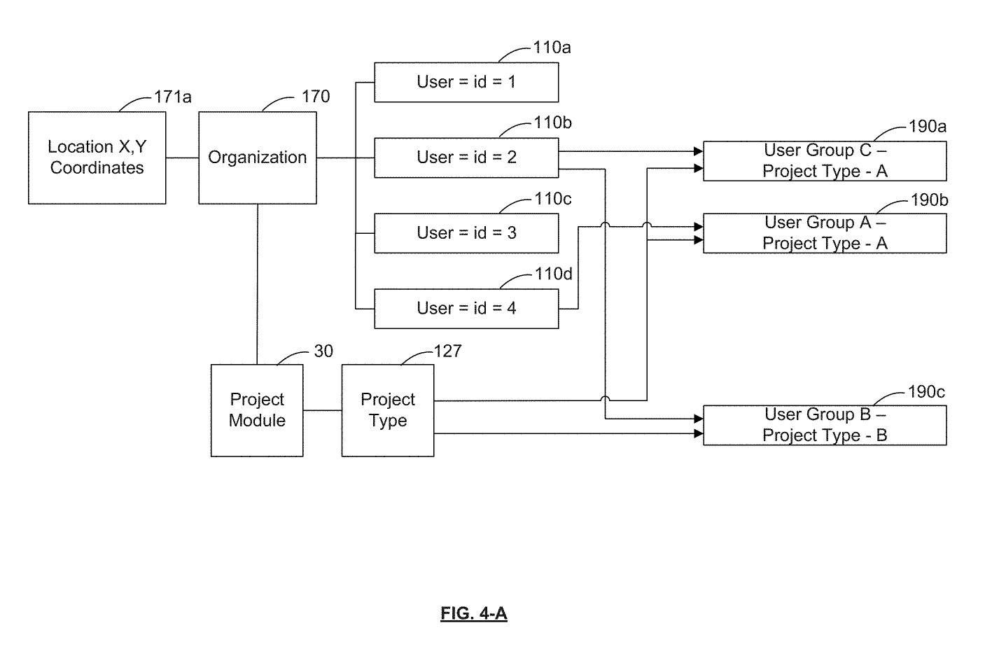

FIG. 2 is an overview of the system functions. The intelligence machine 10 may perform functions related to maintaining user profiles 110, projects 120, events 130, feedback 140, learning resources 150, badges 160, organizations 170, challenges 180, and groups 190 in the system. As illustrated in FIG. 1, the intelligence machine 10 may be coupled to a user module 40. Accordingly, the intelligence machine 10 may cooperate with the user module 40 to maintain user profiles 110. As well, the intelligence machine 10 may be coupled to a project module 30 and may cooperate with the project module 30 to maintain projects 120. The application server 11 also includes a hosting module 90 for managing various applications to operate on different platforms or interfaces. Examples include but not are limited to a web browser 91, Android 92, iOS 93, Windows 94, Blackberry 95, and Linux 96.

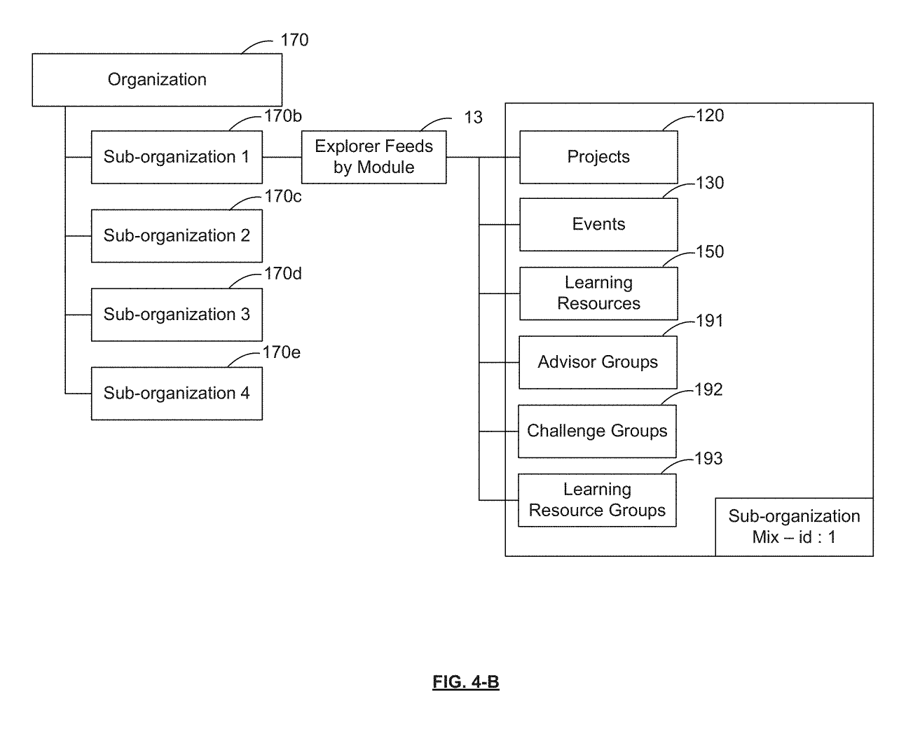

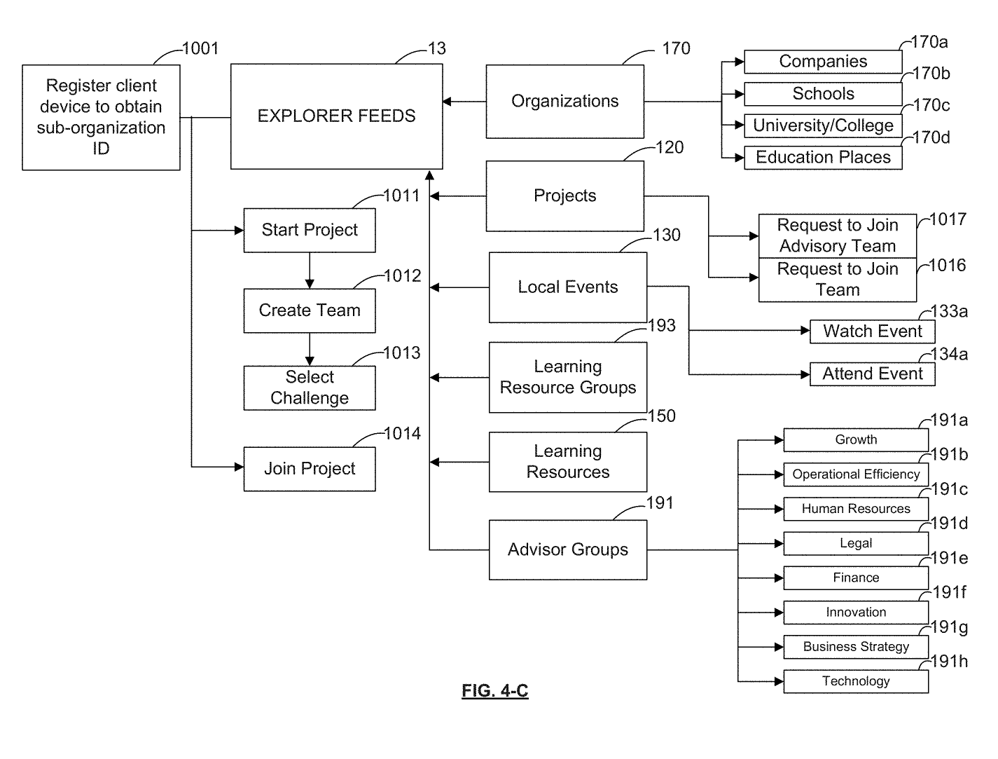

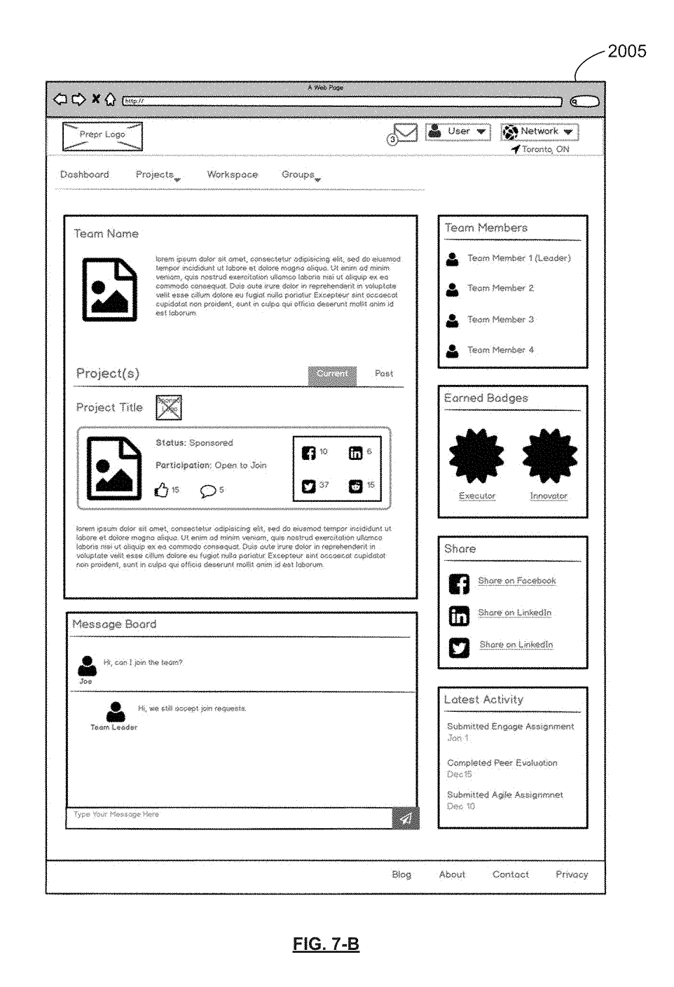

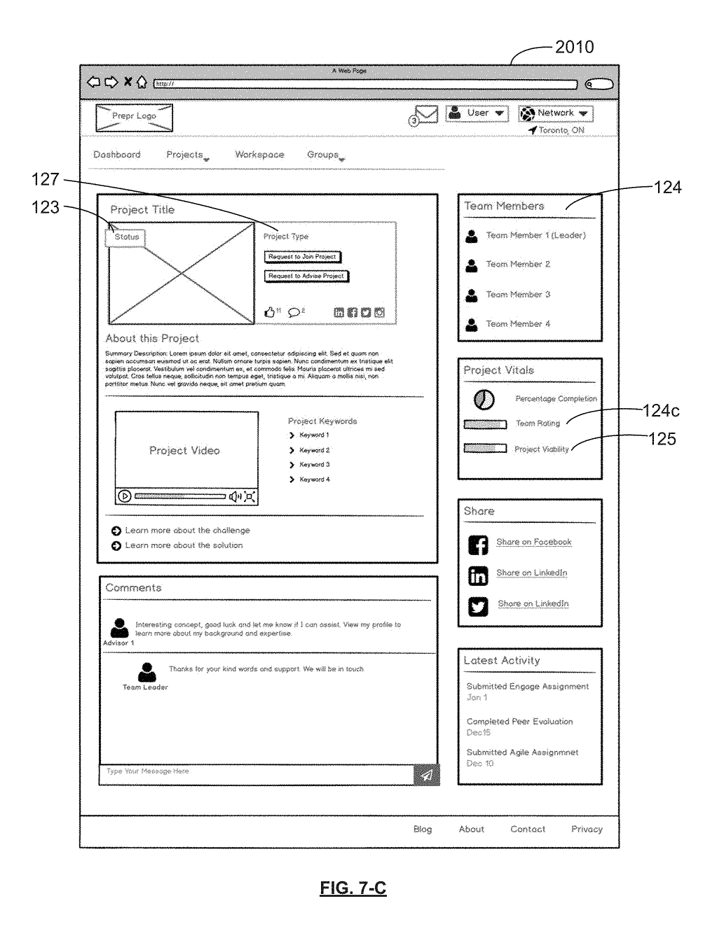

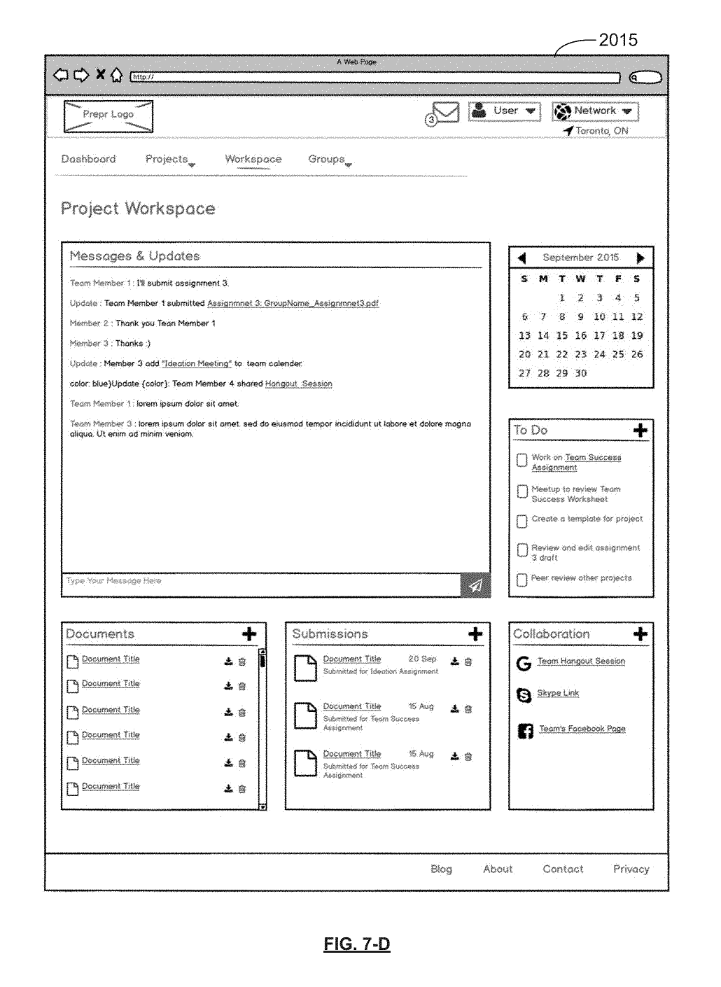

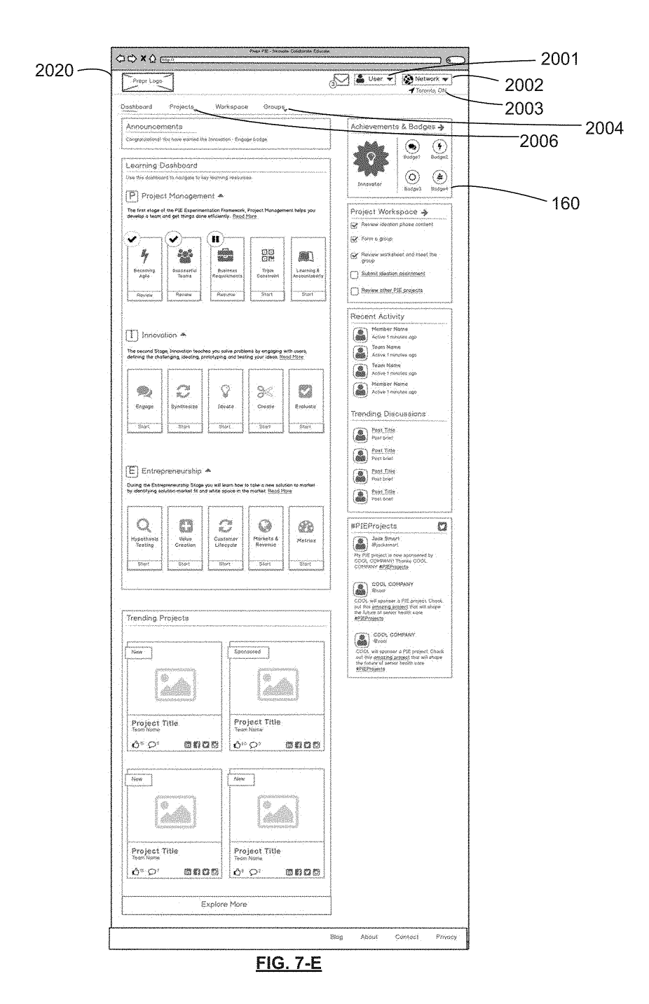

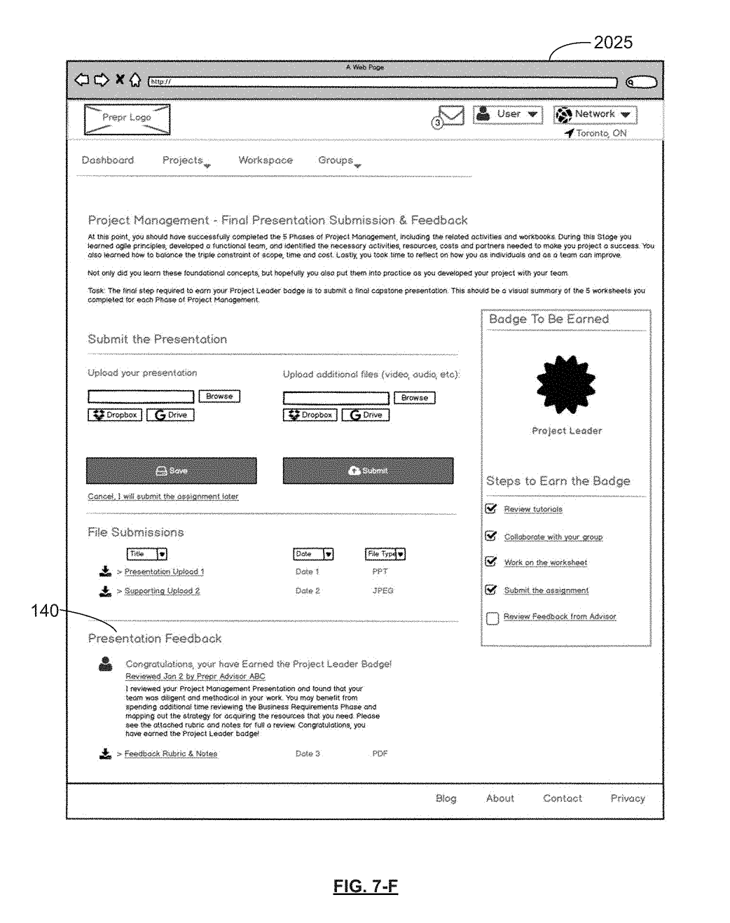

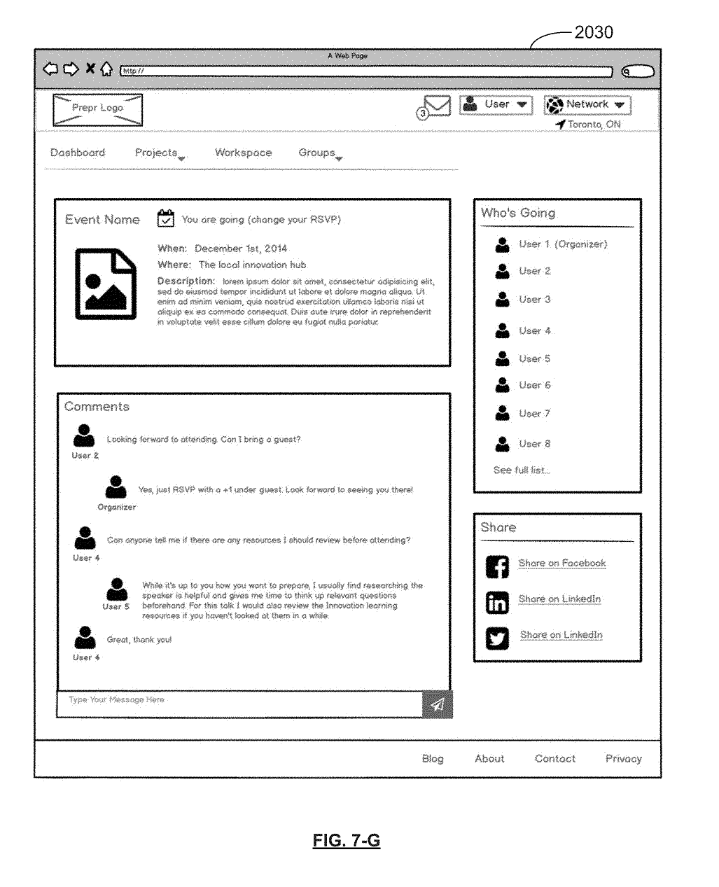

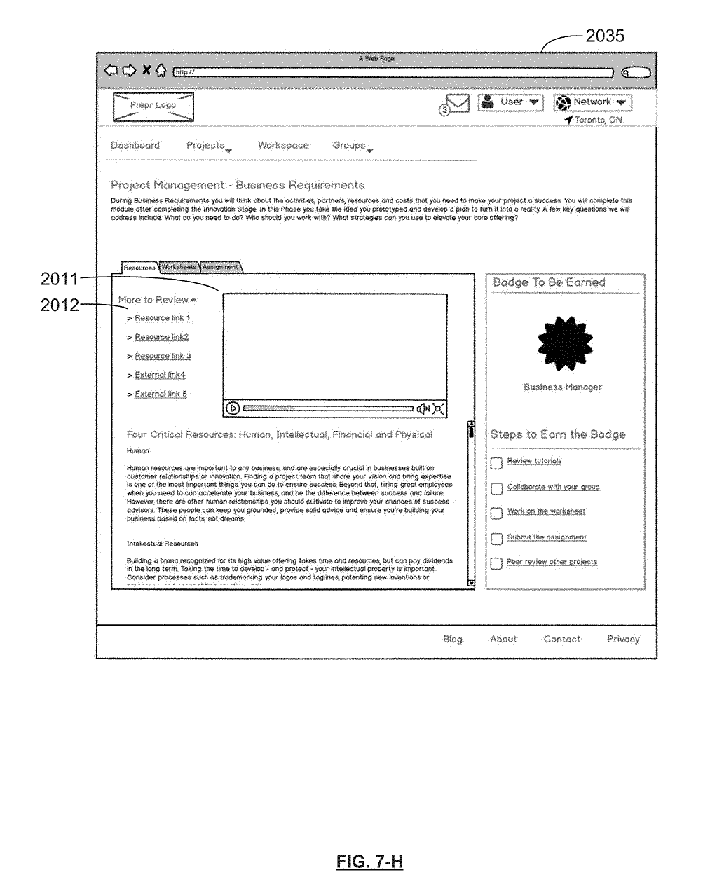

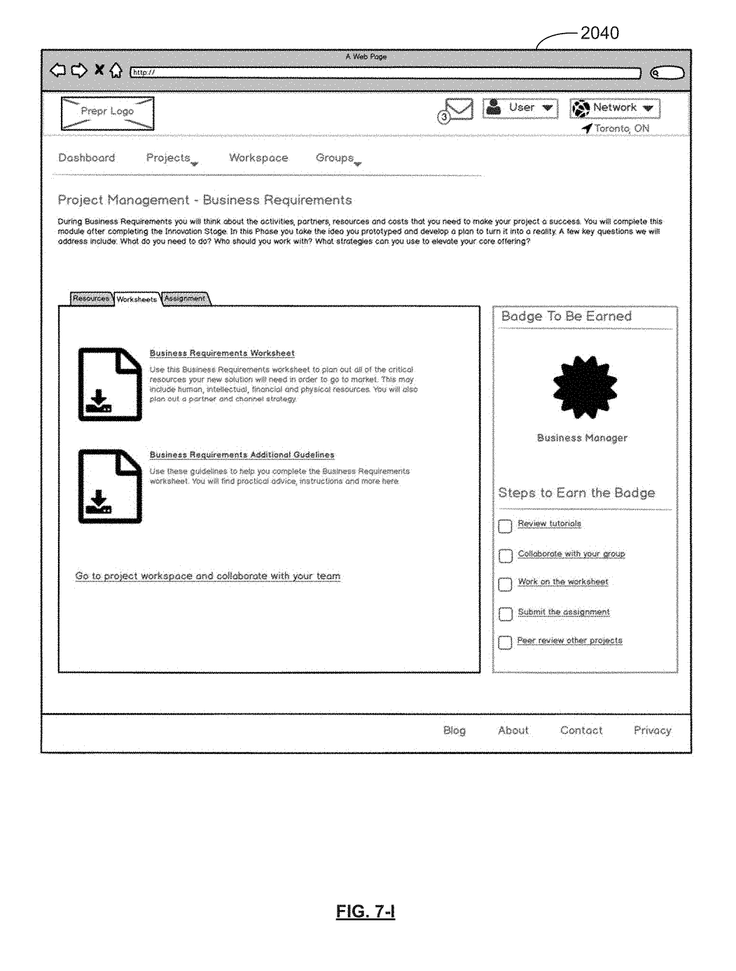

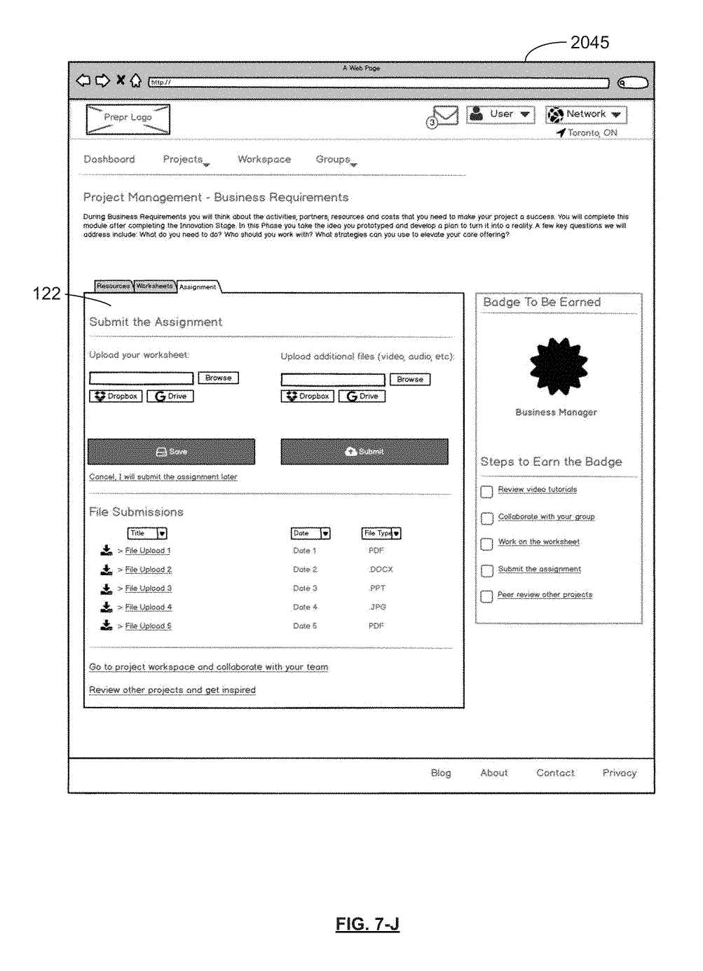

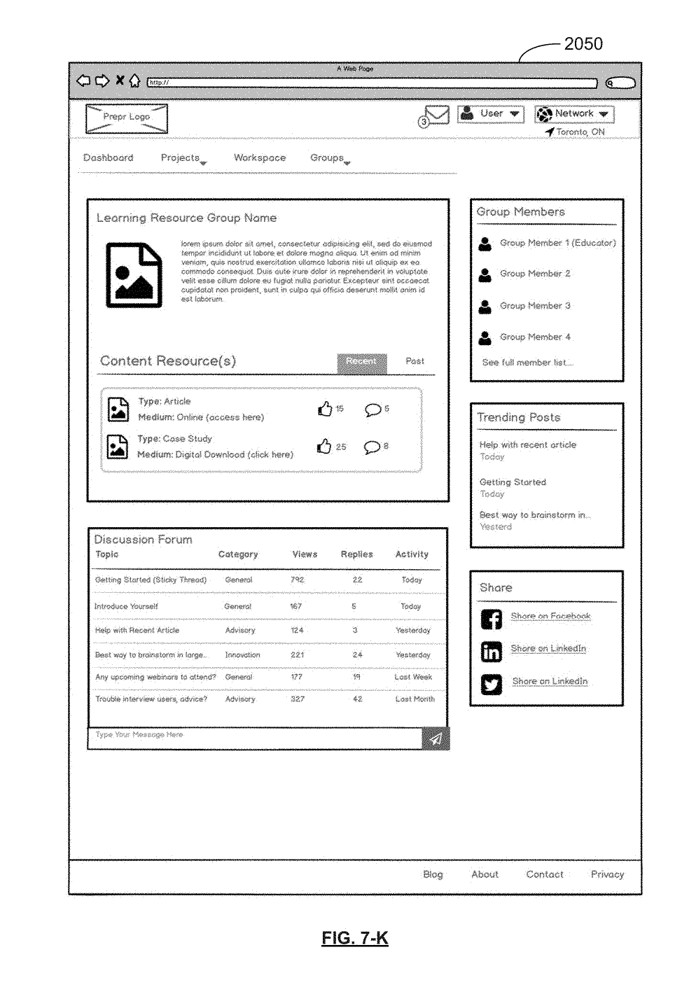

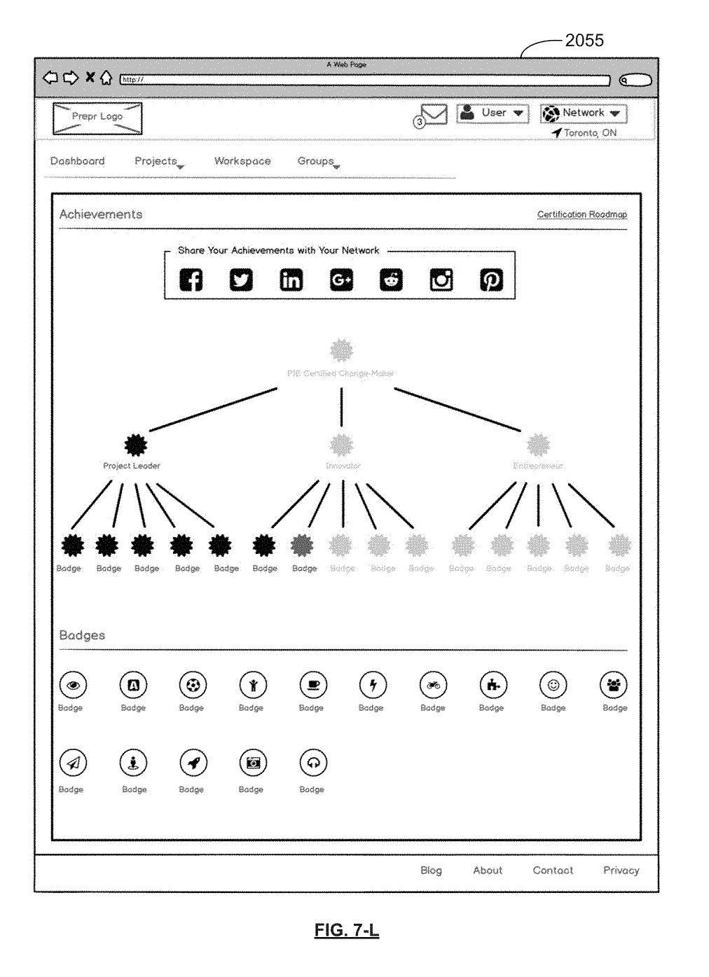

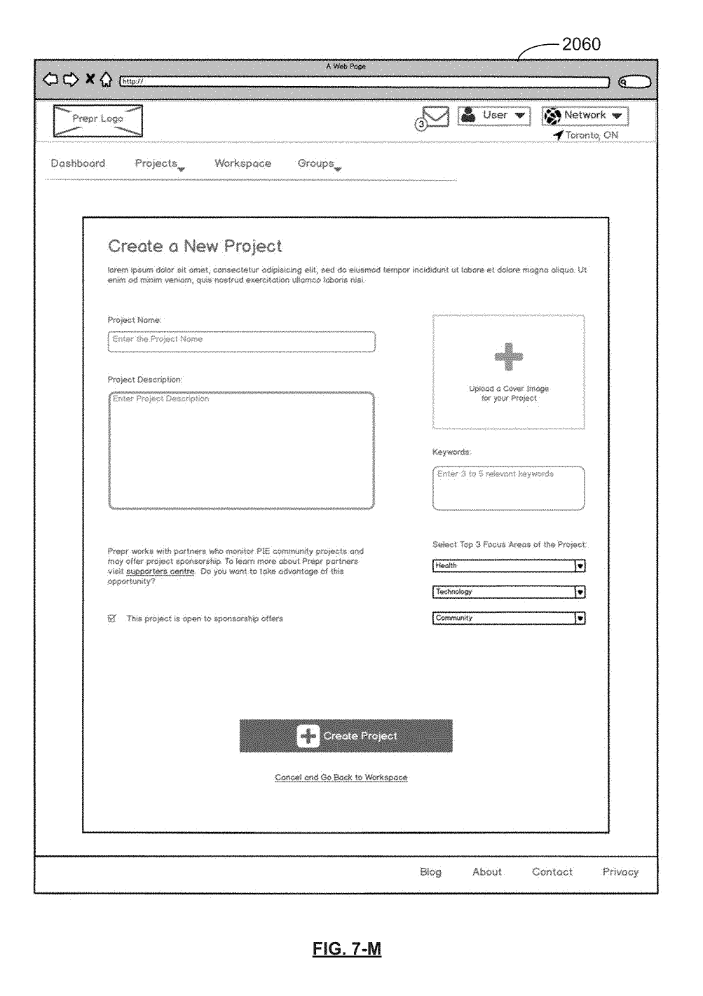

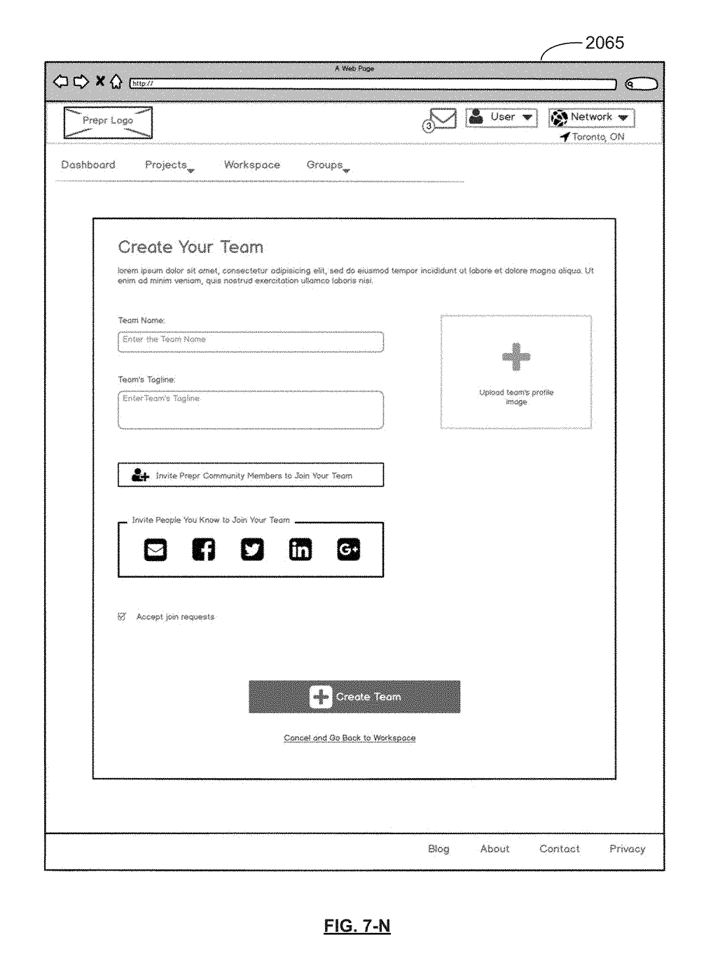

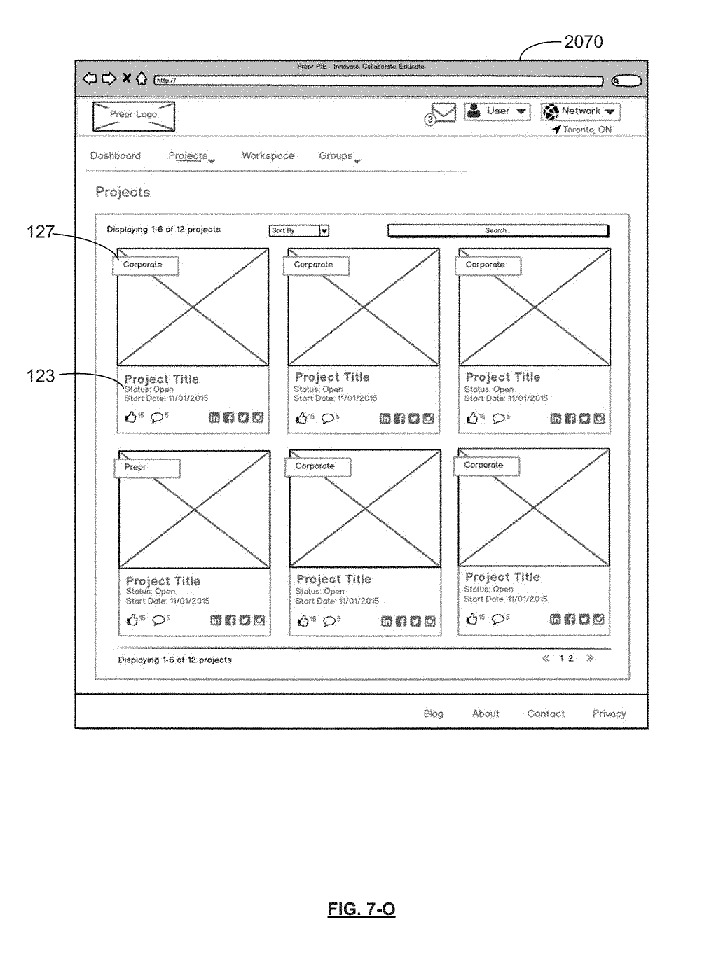

FIG. 3-A is an illustration of information related to a user profile 110 in at least one embodiment. The information related to a user profiles 110 may be displayed, or accessed, from a user profile page. An example of a user profile page 2000 in at least one embodiment is shown in FIG. 7-A. Information related to a user profile 110 may be provided by users. Information related to a user profile 110 may also be determined by the system 100, namely by the intelligence machine 10 or the user module 40. Examples of user information provided by users in at least one embodiment includes a user type, name, and contact information (not shown). User types include, but are not limited to, an educator 111, an advisor 112, a learner 113, and organizational administrator 114. An example of user information determined by the system 100 includes metadata and event attendance data.

For each of the different user types, different information may be stored. In respect of educators 111, the system 100 may store an institution of higher education 115a, department 115b, and role 115c that the educator 111 belongs to. Alternatively, the system 100 may store a school board district 116a, school 116b, and role 116c that the educator 111 belongs to. For educators 111, the system 100 may store, for example, the courses taught 115d, the area of expertise 115e, portfolio information 115f, and projects evaluated 115g. For each of these items, the system 100 may also note whether this information is self-reported 115h or publicly recognized 115i. Portfolio information 115f may include awards, badges 160, recognition, publications, and patents.

In respect of advisors 112, the system 100 may store, for example, companies served 117a, projects advised 117b, areas of expertise 117c, and portfolio information 117d. Again, for each of these items, the system 100 may also note whether this information is self-reported or publicly recognized. Portfolio information 117d may include awards, badges 160, recognition, publications, and patents.

In respect of learners 113, the system 100 may store, for example, the learner's education 118a, portfolio information 118b, projects completed 118c, and areas of expertise 118d. Again, for each of these items, the system 100 may also note whether this information is self-reported or publicly recognized. Portfolio information 118b may include awards, badges 160, recognition, publications, and patents.

In respect of organizational administrators 114, the system 100 may store, for example, the user's position (not shown) within the organization 170. The system 100 may also store a relationship between organizational administrators 114 and a challenge 180 that organizational administrators 114 have created 114a, or created on behalf of the organization 170 that organizational administrator 114 are linked to. The system 100 may store the projects 120 that organizational administrators 114 have sponsored 114b, or sponsored on behalf of the organization 170 that organizational administrators 114 are linked to.

User information may relate to other functions of the system 100. As noted above, user information may relate to badges 160 (via portfolio information) that the user has earned, or earned and maintained; organizations 170 that the user may be linked to; challenges 180 that the user may have created; or projects 120 that the user has sponsored. User information may also relate to a role that a user has in relation to, or in association with, a project 120. That is, a user may be a learner with respect to a first project but simultaneously be an advisor with respect to a second project. In at least one embodiment, a user may be associated with a project 120 if the user is any one of the following: a learner of the project 118c, advised the project 117b, evaluated to the project 115g, sponsored the project 114b, or provided feedback to the project.

User information may also relate to a status that a user has in relation to stages of a learning program. A learning program may be a plurality of learning resources 150. User information may also relate to badges 160, that is, badges 160 that they have earned, and maintained, within the system 100. User information may also relate to feedback 140 that a user has received from a second user, or feedback 140 that a user has provided to a second user or to a project 120. User information may also relate to memberships to groups 190 within the system 100.

Generally, groups 190 may be a plurality of users. For each group 190, different information may be stored, including but not limited to group content, a group type, group metadata, and a group rating. The information related to a group 190 may be displayed, or accessed, from a group profile page. Examples group profile pages 2005 and 2050 in at least one embodiment are shown in FIG. 7-B and FIG. 7-K. Groups 190 may be user groups because they are created by users. Groups 190 may also be system groups, which are pre-existing and not created by users.

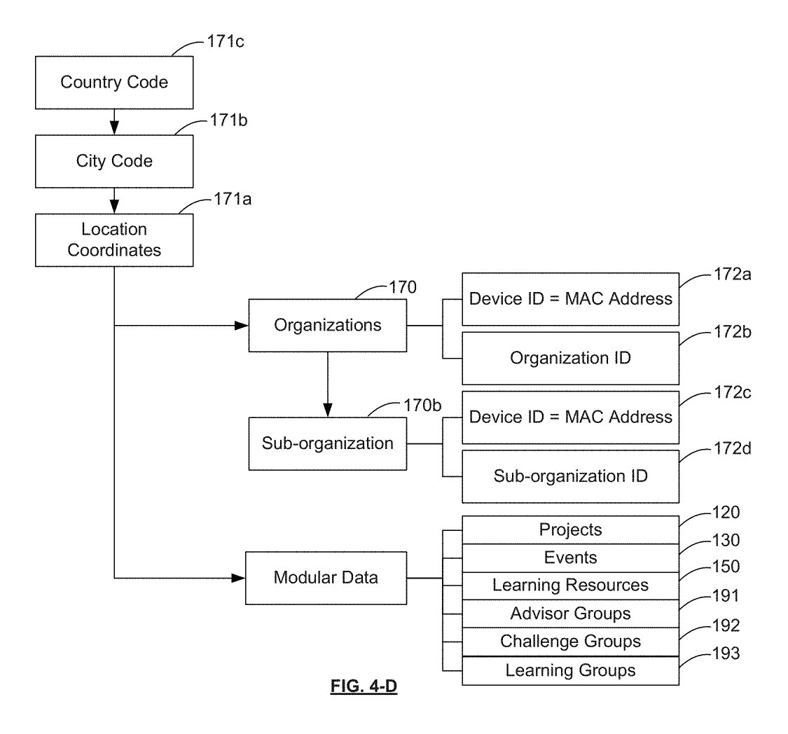

Types of user groups include a project team or group (not shown), an advisor group 191 (shown in FIG. 4-B), a challenge group 192 (shown in FIG. 4-B), study groups (not shown), and meet-up or event groups (not shown). A system group may be a learning resource group 193 (shown in FIG. 4-C). Learning resource groups generally include educators 111. Similarly, advisor groups generally include advisors 112. Challenge groups generally include organizational administrators 114. Advisor groups 191 may be focused on a particular subject matter such as, but not limited to, growth 191a, operational efficiency 191b, human resources 191c, legal 191d, finance 191e, innovation 191f, business strategy 191g, and technology 191h (shown in FIG. 4-C). The system 100 may receive ratings from users with respect to the group 190 and aggregate the ratings to provide a group rating. Groups 190 may be formed to provide an evaluation of a user's skills. The evaluation of a user's skills may also be used to make recommendations for personal development. The evaluation of a user's skills may be used to evaluate projects and make recommendations for project development.

FIG. 3-B is an illustration of information related to a project 120 in at least one embodiment. The information related to a project 120 may be displayed, or accessed, from a project profile page. An example of a project profile page 2010 in at least one embodiment is shown in FIG. 7-C. Information related to a project 120 may be provided by users, upon project creation or as the project progresses. Information related to a project 120 may also be determined by the system 100, namely by the intelligence machine 10 or the project module 30. Examples of project information provided by users in at least one embodiment includes a project type 127 and project content (shown in 2015 of FIG. 7-D). Project types 127 include, but are not limited to challenges 127a, educational 127b, startup/micro 127c, small or medium enterprise 127d, or large enterprise 127e. When a project is a challenge project type, the project 120 may have a linked relationship to, or be associated with a challenge 180. For all project types 127, the system 100 may also determine the location of the project 127f, 127h, 127j, 1271, and 127n. For all project types 127, the system 100 may also determine the node proximity, that is, the geographical distance between client devices 60 (i.e., users) of the same project 127g, 127i, 127k, 127m, and 127o.

In at least one embodiment, project information includes information about the project team 124. This information may include a number of team members of the project 124a, an individual team member rating or grade that is based on user profiles 110 of team members 124b, and a collective team rating or grade that is based on user profiles 110 of team members 124c. Both, a team member rating and a team rating that are based on user profiles 110 are examples of information related to a project 120 that may be generated by the system 100.

In at least one embodiment, project information includes a project status 123. Project statuses 123 may indicate whether a project is active 123b, on hold 123c, or closed 123a. Generally, a project 120 may be active 123b once it has been created by a user. While a project 120 is active 123b, other users 110 may join the project. Generally, after a project 120 is completed, the project status 123 may be closed. In at least one embodiment, the project status 123 may be more specific. That is, the project status 123 may be completed. Before a project is completed, a project team may stop working on the project 120 and the project status 123 may be on hold. If the project team decides to continue the project 120, the project status 123 may return to being active 123. A project 120 may also be cancelled. Alternatively, a cancelled project status 123 may simply be closed 123a.

In at least one embodiment, project statuses 123 may also represent a hierarchical structure by project status 123 classified as being “primary” and “secondary”, or other suitable categories. A primary project status may also have secondary project statuses that relate to sub-stages of the project stage. An example of primary project statuses having secondary project statuses is shown in FIG. 7-E. In at least one embodiment, primary project status may include an Innovation status, an Entrepreneurship status, and a Project Management status. In at least one embodiment, the Innovation primary project status may relate to, but is not limited to, the following secondary project statuses: Engage, Synthesize, Ideate, Create, and Evaluate. In at least one embodiment, the Entrepreneurship primary project status may relate to, but is not limited to, the following secondary project statuses: Hypothesis Testing, Creating Value, Customer Lifecycle, Markets & Revenue, and Metrics that Matter. In at least one embodiment, the Project Management primary project status may relate to, but is not limited to, the following secondary project statuses: Becoming Agile, Successful Teams, Business Requirements, Triple Constraint, and Learning Loops.

In at least one embodiment, the transition between primary project statuses may be unstructured. For example, after completing a project stage, the project status 123 may transition from Innovation to either Entrepreneurship or Project Management. In at least one embodiment, the transition between secondary project statuses may be structured. For example, the secondary project status of Synthesize must transition to Ideate in the primary project status of Innovation.

In at least one embodiment, the system 100 may enable project team members at client devices 60 to provide information to the system 100 at each project status 123 during the life of the project 120. Providing such information may mark project milestones 121. Project milestones 121 may be related to subprojects, work packages, sprints 122. Work packages or sprints 122 may be project tasks, assignments, or deliverables to be completed in relation to the project 120. Generally, project tasks will improve the project 120. The system 100 may also determine the location 122a of, and the node proximity 122b of users that complete the work packages or sprints 122. In at least one embodiment, a project milestones 121 may be related to a phases of a project within a structured method. Thus, project milestones 121 may relate to project progression and assessment. In at least one embodiment, the system 100 may further compare actual project milestones achieved against scheduled project milestones.

As shown in FIG. 7-C, in at least one embodiment, a project profile page 2010 may include, but is not limited to, the project name; a summary project description; project keywords; a challenge that the project responds to; project team members; a project video; a problem addressed by the project; the audience, including users and customers of the project; the project's solution to the problem; a description of the project's solution is preferred over existing solutions, if any; the cost of the product or service offered by the project; images or diagrams of product or service offered by the project; photos related to the problem or solution of the project; frequently asked questions; and an extended project description.

Projects 120 may have rating or grade 126 that is assigned to advisors of a project 120. An advisor rating or grade 126 is another example of information related to a project 120 that may be generated by the system 100.

Projects 120 may also have a project viability rating or grade 125, generated by the system 100. The project viability rating or grade 125 may be determined based on project information and the users associated with the project. The system 100 may determine a project viability rating or grade for a project by aggregating structured and unstructured information related the project and the project team. Project viability may include a component that is based on the market and competitors for the project. Project viability may also include a component that is based on the project team's ability to execute the project.

Any suitable information may be used to determine project viability, including, but not limited to, information shown in FIGS. 3-A to 3-G. The information may be collected over time. In addition, the information collected may be based on the status of the project and the composition of the project team.

In at least one embodiment, information related to the project that may affect project viability includes, but is not limited to market data; whether the market is existing, new, re-segmented, or a clone; the size of the total, target, and available market; the problem addressed by the project; the defined user and customer of the project; user validation via social sharing; customer validation via crowd-funding; the solution to the problem; the prototype for the project (iterative, demonstrated learning and enhancement); the value proposition of the project; customer channels; multi-sided and single sided revenue models; and the type of organization delivering the project, such as a for-profit, non-profit, or fair-trade corporation.

In at least one embodiment, information related to the project team that may affect project viability includes, but is not limited to, project history, education, skill development, event attendance history, location history of team members, interaction amongst team members and mentors, available financial, facilities, and equipment resources, scope of a minimum viable product, and existing partnerships. In particular, information about skill development may relate to whether the team members have completed all modules of a learning program; whether team members implemented and resubmitted modules based on feedback received; the amount of time team members spent reviewing learning resources in the system. Information about interaction amongst team members and mentors may relate to whether the project team formed with clear roles for each team member; the commitment of team members, measured by time and availability; and the strength of the team's network for early adoption and investment.

FIG. 3-C is an illustration of the information that may be collected, tracked, and stored about the interaction of a user 110 with projects 120 in at least one embodiment. The system 100 may track and store a total number of interventions that a user takes across all projects 165. The total number of interventions across all projects 165 may depend on the medium of intervention; that is, whether the intervention is physical 165a or digital 165b. Interventions that are a physical type may be in-person 165c or event-specific 165d. The system 100 may also determine a location 165e and a node proximity of physical type interventions 165f. The node proximity may be determined on an individual basis, that is, advisor to educator to learner 165g. The node proximity may also be determined on a team basis, that is, learner to team 165h. Interventions that are digital may be an email or a posted question 165i, or a web-conference 165j. Each of the digital interventions may involve user selection within the system 100 so that the system 100 may track the user's participation in the digital event 165b. In at least one embodiment, the digital event may relate to content external to the system 100 but requires a user to make a selection, such as a hyperlink, within the system 100.

The system 100 may also track and store a total number of interventions that a user takes for a particular project 166. The system 100 may further track whether an intervention for a particular project occurred a specific phase or milestone 166a. The system may also collect, track, and store feedback insight 167. Generally, feedback insight 167 represents analysis of feedback 140 that a user provides for a project, or the team of a project. Accordingly, such feedback insight may relate to a project 167b, or a project team 167a. Feedback insight may be keyword sentiment by evaluation category/segment 167c and 167d. That is, feedback may include qualitative information, such as text provided as comments. The qualitative feedback may be parsed to identify keywords. Also, feedback may include quantitative information, such as data based on a rating scale. The system may also store a category 168 for vertical 168a or horizontal advisors 168b. Advisors generally have specific skills 168c and 168d. Vertical advisors may be advisors for skills in a specific industry. In contrast, horizontal advisors may be advisors for skills that are applicable to a variety of industries. Advisors' skills may be retrieved from an external database 70 such as LinkedIn®.

FIG. 3-D is an illustration of feedback 140 that may be collected, tracked, and stored in at least one embodiment. The system may accept various types of feedback, including but not limited to, self-review 141, team peer review 142, team project review 143, external project review 144, and external team review 145. Self-review 141 may be feedback that users provide about themselves. Team peer review 142 may be feedback that a user 110 in a project provides about other users in the same project. Team project review 143 may be feedback that a user 110 in a project provides about that project. External project review 144 may be feedback that a user provides about a project that they are not in. External team review 145 may be feedback that a user provides about a team of a project that they are not in. An example of feedback 140 provided to a user is shown in FIG. 7-F, which shows a file submission and feedback page 2025 in at least one embodiment. After a user uploads files (in this case, a presentation) to the system 100, other users may provide feedback about the file. The feedback provided may relate to the uploaded file, or the user's presentation related to the uploaded file.

Feedback related to a user, that is, for a user or from a user, may be displayed, or accessed, from a feedback profile page. The system may store metadata, such as location data 141a, 142a, 143a, 144a, and 145a, related to the feedback 140. The system may also determine the node proximity 141b, 142b, 143b, 144b, and 145b for the feedback. That is, the system may determine the node proximity between users that provide feedback to users that are the subject of the feedback. The self-review node proximity 141b relates to the proximity of a user providing self-review to advisors and educators 141c and to team members 141d. The node proximity may be determined on an individual basis, that is, advisor to educator to learner 141c, 142c, 143c, 144c, and 145c. The node proximity may also be determined on a team basis, that is, learner to team 141d, 142d, 143d, 144d, and 145d.

FIG. 3-E is an illustration of information that may be collected, tracked, and stored for events 130 in at least one embodiment. The information related to an event 130 may be displayed, or accessed, from an event profile page. An example of an event profile page 2030 in at least one embodiment is shown in FIG. 7-G. Information related to an event 130 may be provided by users, upon event creation or in the time leading up to an event. Information related to an event 130 may also be determined by the system 100, namely by the intelligence machine 10. Examples of event information provided by users in at least one embodiment includes an event type, an event name, and an event description. Event mediums include digital events 133a and 135a and physical events 134a and 136a. In at least one embodiment, the system 100 may also determine the location of physical events 134b and 136b and the node proximity of the physical event 134c and 136c, that is, the geographical distance between client devices 60 (i.e., users) attending the same event. The node proximity may be determined on an individual basis, that is, advisor to educator to learner 134d and 136d. The node proximity may also be determined on a team basis, that is, learner to team 134e and 136e.

An example of event information determined by the system 100 includes attendance data. Attendance data may relate to particular users, for example, whether they attended 131 or missed 132 the event. Attendance data may also relate to aggregate data, such as a total number of attendees.

FIG. 3-F is an illustration of information that may be stored for learning resources 150 in at least one embodiment. The system 100 may collect and track information related to a user's engagement with learning resources and projects 151. User engagement with learning resources and projects may be tracked by events such as clicking on links, playing videos, downloading resources, opening worksheets. User engagement with learning resources and projects may also be tracked by user activities such as group or forum participation and assignment or worksheet submission.

The system 100 may monitor a user's engagement on different bases such as month-over-month 153, year-over-year 154, or across projects 155. Furthermore, the system 100 may further determine the engagement based on the status of those projects 155a, 155b, and 155c. For learning resources and projects, the system 100 may also determine the location 156 of client devices engaged with learning resources and the node proximity 157, that is, the geographical distance between client devices 60 (i.e., users) engaged with the same learning resource. The node proximity 157 may be determined on an individual basis, that is, advisor to educator to learner 157a. The node proximity 157 may also be determined on a team basis, that is, learner to team 157b. Furthermore, the node proximity 157 from advisor to educator to learner to team may be determined based on the node proximity from advisor to educator to learner 157a and the node proximity from learner to team 157b. For example, the node proximity from advisor to educator to learner 157a may be added with the node proximity from learner to team 157b to determine the node proximity from advisor to educator to learner to team.

The system 100 may also recommend learning resources 152 to a user and maintain information related to a user's interaction with recommended learning resources 152. The system may assess user development and recommend learning resources to enhance future learning. The recommend learning resources may form a learning path that is related to a particular stage or environment of a project group that the user is a team member of. Learning resources may be recommended in discrete sets, packets, or buckets, for traceability by the user and the system 100. Recommended learning resources may be determined based on a user profile and project groups that the user is a part of. The system 100 may aggregate structured and unstructured information related to the user profile and project groups that the user is a member of. Any suitable information may be used to determine recommended learning resources, including but not limited to, information shown in FIGS. 3-A to 3-G. The information may be collected over time.

In at least one embodiment, information related to a user profile includes, but is not limited to, education history; external resources 70 accessed; badges earned 161; event attendance history; and location history. In at least one embodiment, information related to project groups that the user is a part of includes, but is not limited to, milestones completed 121, interaction amongst team members and mentors, and the project viability.

The system 100 may monitor this interaction based on the learning resource medium. The learning resource medium may be digital 158 or in the physical world 159. For digital learning resources 158, the information may further distinguish whether the learning resource is asynchronous 158a, synchronous 158b, software tools 158c, or open source 158d. For learning resources in the physical world 159, the information may further depend on whether the learning resource relates to hardware or a device 159a. For recommended learning resources, the system 100 may also determine the location 159b of client devices interacting with recommended learning resources and the node proximity 159c, that is, the geographical distance between client devices 60 (i.e., users) interacting with the same learning resource in the physical world. The node proximity 159c may be determined on an individual basis, that is, advisor to educator to learner 159d. The node proximity 159c may also be determined on a team basis, that is, learner to team 159e.

Learning resources may be displayed, or accessed, from a learning resource profile page. Examples of learning resource profile pages 2035, 2040, and 2045 in at least one embodiment are shown in FIGS. 7-H, 7-I, and 7-J. Learning resources may be learning resource content 2011 stored in the database 20 or links 2012 to learning resource content in external databases 70. The learning resource profile page 2045 shows how assignment, which may be required for a work package 122, may be submitted.

In at least one embodiment, the system 100 may further include learning resource groups 193 (shown in FIG. 4-B). Learning resource groups 193 may include a plurality of learning resources 150 and a plurality of users 110. Information related to a learning resource group may be displayed, or accessed from a learning resource profile page. An example of a learning resource group profile page 2050 in at least one embodiment is shown in FIG. 7-K. Information related to a learning resource group 193 includes a learning resource type, learning resource group content, learning resource group medium, and learning resource metadata. In at least one embodiment, the learning resource group may be recommended to a learner 113 by the intelligence machine 10. The learner 113 may contact the learning resource group for assistance and access to learning resource content. Learning resources groups may be digital, in which the groups generally interact online. Learning resources groups may be physical, in which the learning resource groups are accessible in-person.

FIG. 3-G is an illustration of information that may be stored for badges 160 in at least one embodiment. Badges may represent a user status, completed learning actions, and project tasks. There may be a plurality of different badge types including, but not limited to, skill badges, knowledge badges, accomplishment badges, participation badges, certificate badges, award badges, challenge badges, and designation badges. For example, skills badges may relate to skills that a user has demonstrated. Similarly, knowledge badges may relate to knowledge that a user has demonstrated. Accomplishment badges may relate to actions, tasks, or assignments that a user has completed within a group or a project. Participation badges may relate to a user's participation in a group. Certificate, award, and designation badges may relate to courses or learning actions that a user has completed. Challenge badges may relate to challenges that a user responded to by joining a project.

Badges 160 may be earned 161. After badges are earned, the system 100 may retain information about the category 161a that the badge relates to, the location 161b and node proximity 161c at which the badge was earned. For badges, the system 100 may also determine the node proximity 161c, that is, the geographical distance between client devices 60 (i.e., users) earning with the same badges. The node proximity 161c may be determined on an individual basis, that is, advisor to educator to learner 161d. The node proximity 161c may also be determined on a team basis, that is, learner to team 161e. Badges may further be maintained 162. Badges may be maintained if certain project cycles are completed 162a. Badges may also be imported from other external databases 70. Third-parties may also verify external or imported badges 162b. Additional information related to badges includes the resubmission requirements (for external or imported badges) and management of badges 162c. Badges may be displayed, or accessed, from a badge profile page. An example of a badge profile page 2055 in at least one embodiment is shown in FIG. 7-L.

In at least one embodiment, the system 100 may include challenges 180. In at least one embodiment, information related to challenges 180 includes a user 110 that initiated the challenge, a type of challenge, and the challenge metadata, and challenge content, such as a challenge statement. Types of challenges include, but are not limited to, industry-specific challenges, sponsor challenges, problem-based challenges, and needs-based challenges. For example, a problems-specific challenge may be created when a company recognizes a problem and requires a solution to the problem. The company may create a problem-based challenge. In response to the problem-based challenge, users 110 may create projects 120 in response to the problem-based challenge.

In at least one embodiment, the system 100 may further include challenge groups. Groups 190 are generally a collection of users 110. Challenge groups may further include a plurality of challenges 180. Challenges 180 in a challenge group are generally only available to users 110 of the challenge group. Challenge groups may be free or paid challenges. Users 110 who create a project in response to a paid-challenge may be compensated by those who initiated the paid-challenge. Challenge groups may further be open or closed groups. Any user 110 may join an open group. Closed challenge groups may have limited membership.

Organizations 170 may be a group of a plurality of users 110, a plurality of groups 190, a plurality of projects 120, a plurality of learning resources 140, and a plurality of feedback 140. In at least one embodiment, organizations may also include a plurality of events 130, plurality of badges 160 and a plurality of challenges 180. The system 100 may collect, track, and store information about the organization, such as the organization type and metadata. Types of organizations 170 include, but are not limited to, incubators, accelerators, innovation centres, startup spaces, companies 170a, schools 170b, universities or colleges 170c, and education places 170d (shown in FIG. 4-C). Education places 170d may include, but is not limited to, museums, galleries, libraries, historic sites, community centres, and co-working spaces. In at least one embodiment, organizations may have dedicated servers and routers. When organizations have dedicated servers and routers, the node proximity or the geographical distance between client devices and the organization server or router may be determined.

FIG. 4-A shows a block diagram of the network structure of the system 100 in at least one embodiment. FIG. 4-A illustrates the relationship of users 110, groups 190, and projects 120 within an organization 170. The physical location 171a of the organization 170 may be stationary. The organization 170, having dedicated servers and routers, may act as a cluster to form a grid of machines, enabling the connection of multiple users. Users, each having user profiles 110a, 110b, 110c, and 110d may connect to organization 170. Users may form, or create groups 190a, 190b, and 190c for their projects. The intelligence machine 10, via the project module 30, may differentiate projects 120 by the type of project 127. In FIG. 4-A, the project module differentiates groups 190a and 190b from group 190c because groups 190a and 190b relate to project type A while group 190c relates to project type B.

FIG. 4-B shows a block diagram of the relationship between an organization 170 and modules in at least one embodiment. Modules may refer to, but are not limited to, the following intelligence machine 10 functions: projects 120, events 130, learning resources 150, and groups 190 such as advisor groups 191, challenge groups 192, and learning resource groups 193. An organization 170 may have sub-organizations 170b, 170c, 170d, and 170e. In at least one embodiment, the organization 170 may be a hot spot-router or a proxy-server. Sub-organizations 170b, 170c, 170d, and 170e may connect to modules of the organization 170 and derive the latest user interaction activity for each module to provide an explorer feed 13.

FIG. 4-C shows a block diagram of the relationship between sub-organizations and modules, in at least one embodiment. A user at a client device 60 may register with a sub-organization. Registration may be performed by providing a time stamp location, and one or more of the following, name, email, user id, social id, and phone number. By registering with a sub-organization, the client device 60 may obtain the sub-organization identifying information. After obtaining the sub-organization identifying information, a user at the client device 60 may start 1011 or create a project 120 to be stored in the database 20 (shown in 2060 of FIG. 7-M). A user at the client device 60 registered with the sub-organization may also join a project 1014 that is stored in the database 20. After starting a project 1011, a user at the client device 60 may further create a team 1012 (shown in 2065 of FIG. 7-N). A user at the client device 60 may also select 1013 a challenge 180 that the project 120 may respond to.

Once registered to the sub-organization, a client device 60 may access the explorer feeds 13 of the sub-organization. The explorer feed 13 may display various items stored in the database 20. For example, a user at the client device 60 may request to join an advisory team 1017 or join a team 1016 of a project 120 that is displayed on the explorer feed 13 shown on their client device 60. A user at a client device 60 may learn of a digital event to watch 133a or a local event to attend 134a in person. An example explorer feeds 2020 is shown in FIG. 7-E.

As shown in FIG. 7-E, explorer feed 2020 illustrates a sidebar containing various items including badges 160, project workspace, recent activity, and content from external sources such as Twitter®. Explorer feed 2020 also displays announcement and a learning dashboard. A first dropdown menu 2001 may be accessed to navigate to a user profile, account, or sign out of the system 100. A second drop down menu 2002 may be accessed to navigate to an organization 170 (shown as “network”). The system 100 may determine and indicate the location 2003 of the client device 60. A third drop down menu 2004 may be accessed to navigate to groups by category of the user's organization 170, and other users of the same organization 170, or community, such as learners 113, advisors 112, and educators 111. Drop down menu 2006 may be accessed to navigate to a project explorer feed 2070 (shown in FIG. 7-O). From project explorer feed 2070, projects 120 having different project statuses or project categories, along with filters 123 may be accessed.

FIG. 4-D shows a block diagram of the relationship between sub-organizations and locations of client devices 60. Location coordinates 171a of an organization may include a city code 171b and further include a country code 171c. Each organization 170 may have identifying data such as a device identifier or MAC address 172a and organization identifier 172b. Each sub-organization 170b may have identifying data such as a device identifier or MAC address 172c and organization identifier 172d. The location coordinates 171a of a client device 60 may be determined based on at least the organization identifier that the client device 60 may connect to. The location coordinates 171a may be stored in the database 20 for various metrics such as the location and node proximity (122a, 122b, 127f to 127o, 165, 141a to 145a, 141b to 145b, 134b, 134c, 136b, 136c, 156, 157, 159b, 159c, 161b, 161c) set out above.

The intelligence machine 10 may analyze the information stored in the database 20 pertaining to user profiles 110, projects 120, events 130, feedback 140, learning resources 150, badges 160, organizations 170, challenges 180, and groups 190. In at least one embodiment, the intelligence machine 10 may parse the information for synthesis.

For each project, the intelligence machine 10 may determine a plurality of project proximity factors. The project proximity factors of a project may represent how project information relates to project performance of that project. The project proximity factors may also represent how user information of users associated with that project relates to the project performance of that project. Each of the project information and user information may be synthesized to determine the project proximity factors. As project information and user information is collected, tracked, and stored in the database 20, the project proximity factors for that project may be updated.

In at least one embodiment, project proximity factors may be based on at least one of, the sales revenue, grant revenue, number of customers, number of users, numbers of partners or types of partners, costs, number of team members, customer acquisition costs, lifetime value, and number of leads.

For each user, the intelligence machine 10 may determine a plurality of user proximity factors. The user proximity factors may represent how user information relates to user development. The user proximity factors may also represent how project information of projects that the user is associated with relates to that user's development. Each of the user information and project information may be synthesized to determine the user proximity factors. As user information and project information is collected, tracked, and stored in the database 20, the user proximity factors may be updated.

The intelligence machine 10 may determine set of master proximity factors. The master proximity factors may include master project proximity factors as well as master user proximity factors. The master proximity factors generally represent a gold-standard, or best practices, for relationships between projects 120, characterized by project information, and users 110, characterized by user information.

Initially, master proximity factors may be determined using information from external databases 70. For example, external databases 70 may be online resources for market data, such as First Research®, Crunchbase®, open data sources, Nielson PRIZM®, comScore® and Environics Analytics. Initial master proximity factors may be subsequently updated with project proximity factors of projects 120 in the database 20 and user proximity factors of user profiles 110 in the database 20 to obtain the master proximity factors. As project proximity factors and user proximity factors are updated in the database 20, the master proximity factors may be updated as well. In at least one embodiment, master proximity factors may be updated with project proximity factors corresponding to projects having certain project statuses, such as a completed and cancelled. In at least one embodiment, master proximity factors may be updated with all projects, irrespective of the corresponding project status for that project.

The intelligence machine 10 may determine an overall viability 22 for a project. Generally, the overall viability 22 may be directed to the capacity that a project may operate or be sustained. The overall viability 22 for a project may be determined based on the master proximity factors. Market viability for a project may be determined based on the non-compliance of project proximity factors with master project proximity factors. Execution viability for a project may be determined based on the non-compliance of user proximity factors with master user proximity factors. The overall viability 22 for a project may be determined based on the market viability and the execution viability.

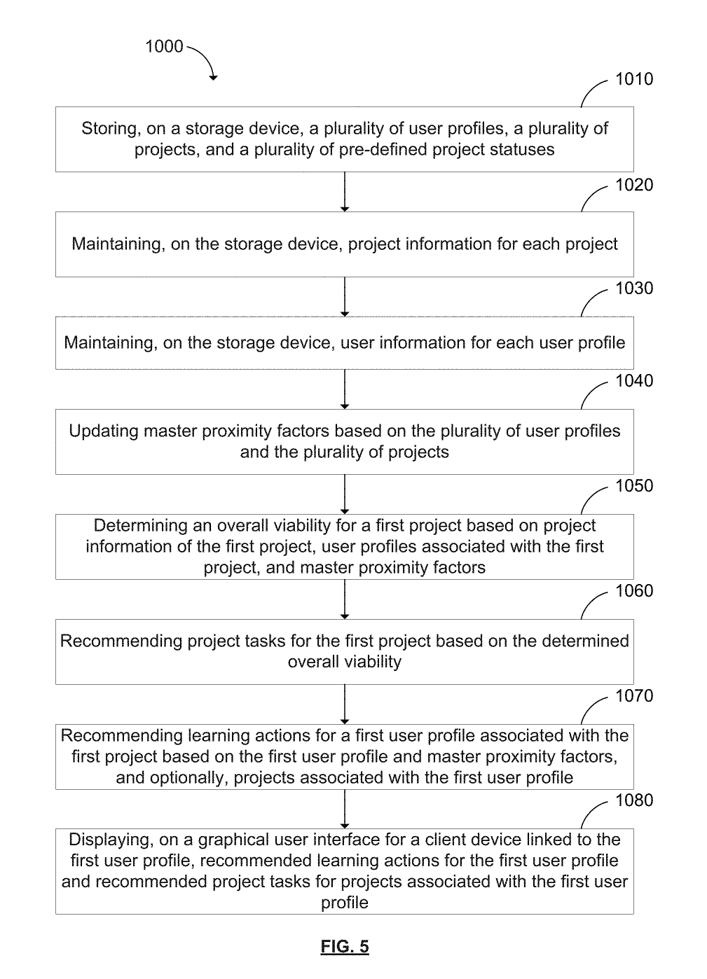

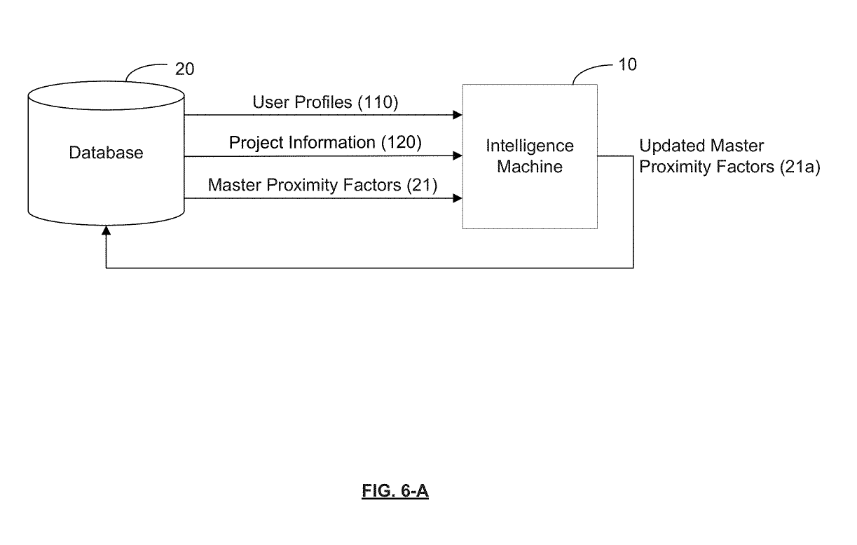

FIG. 5 is a flowchart showing a method 1000 of providing hybrid innovation and learning management. At step 1010, a storage device, or database 20, stores a plurality of user profiles 110, a plurality of projects 120, and a plurality of project statuses 123. The user profiles 110 and the projects 120 may be initially created by a user at a client device 60.

At step 1020, the application server 11 may maintain project information for each project 120, on the database 20. Projects 120 may progress with the completion of tasks. Projects 120 may include tasks that are performed outside of the system 100. In such cases, the completion of such tasks may be inputted to the system 100 by a user. Projects 120 may also include tasks that are performed within the system 100. In such cases, the completion of such tasks may be automatically monitored by the system 100. The system 100 may change the project status 123 according to the completion of tasks.

In at least one embodiment, the system 100 may enable project team members to provide a project title, a project objective, and an industry or field when a primary project status is Innovation. When the primary project status is Innovation, project team members may generally provide information that identifies who the end user for the project is, defining a problem addressed by the project, generating ideas, prototyping ideas, and evaluating and improving prototypes.

In at least one embodiment, the system 100 may enable project team members to identify an end user for the project when the primary project status is Innovation and a secondary project status is Engage. In at least one embodiment, the system 100 may enable project team members to define a problem being addressed by the project when the primary project status is Innovation and a secondary project status is Synthesize. In at least one embodiment, the system 100 may enable project team members to create a mind map of ideas for the project when the primary project status is Innovation and a secondary project status is Ideate. In at least one embodiment, the system 100 may enable project team members to create prototype solutions when the primary project status is Innovation and a secondary project status is Create. In at least one embodiment, the system 100 may enable project team members to test solutions and iterate based on findings when the primary project status is Innovation and a secondary project status is Evaluate.

In at least one embodiment, the system 100 may enable users to join the project and become team members when a primary project status is Entrepreneurship. When the primary project status is Entrepreneurship, project team members may generally provide information that identifies testing ideas in the market environment, determining the value proposition of the project for users and customers, identifying how to obtain new customers and maintain customers, via loyalty, upselling, cross-selling, and referrals. When the primary project status is Entrepreneurship, project team members may also identify the market type, available size of the market, revenue models, and analytical metrics.

In at least one embodiment, the system 100 may enable project team members to identify assumptions made in the project and to test the assumptions when the primary project status is entrepreneurship and a secondary project status is Hypothesis Testing. In at least one embodiment, the system 100 may enable project team members to develop the value proposition created by the project when the primary project status is entrepreneurship and a secondary project status is Creating Value. In at least one embodiment, the system 100 may enable project team members to identify the customer acquisition and loyalty funnel for the project when the primary project status is entrepreneurship and a secondary project status is Customer Lifecycle. In at least one embodiment, the system 100 may enable project team members to identify the market type and revenue model for the project when the primary project status is entrepreneurship and a secondary project status is Markets & Revenue. In at least one embodiment, the system 100 may enable project team members to identify key metrics when the primary project status is entrepreneurship and a secondary project status is Metrics that Matter.

In at least one embodiment, the system 100 may enable users to join the project and become team members, and project team members to track milestones and financial information when a primary project status is Project Management. When the primary project status is Project Management, project team members may generally provide information that can be used to create work flows and processes, build teams, identify business requirements such as activities, partners, resources, and costs, manage the constraints of time, cost, and scope, and organizational learning.

In at least one embodiment, the system 100 may enable project team members to build a milestones timeline for the project and identify work packages for the project when the primary project status is Project Management and a secondary project status is Becoming Agile. In at least one embodiment, the system 100 may enable project team members to identify roles for team members when the primary project status is Project Management and a secondary project status is Successful Teams. In at least one embodiment, the system 100 may enable project team members to identify activities, partners, resources, and costs for the project when the primary project status is Project Management and a secondary project status is Business Requirements. In at least one embodiment, the system 100 may enable project team members to define the project scope, estimate time and cost for the project, and prioritize features when the primary project status is Project Management and a secondary project status is Tripe Constraint. In at least one embodiment, the system 100 may enable project team members to identify lessons learned and next steps when the primary project status is Project Management and a secondary project status is Learning Loops.

In at least one embodiment, the system 100 may enable project team members to track milestones and financial information when a primary project status is completed.

In at least one embodiment, the system 100 may enable users who are not team members of the project to provide feedback about the project when the primary project status is at any one of the Innovation, Entrepreneurship, and Project Management primary project statuses.

At step 1030, the application server 11 may maintain user information for each user profile 110, on the database 20. Users may develop and enhance their skills as they engage with learning resources and projects. Engagement with learning resources and projects may be a part of learning program or lone-standing. Engagement with learning resources and projects within the system 100 are automatically monitored by the system 100. Engagement with learning resources and projects outside of the system 100 may be inputted to the system 100 by a user.

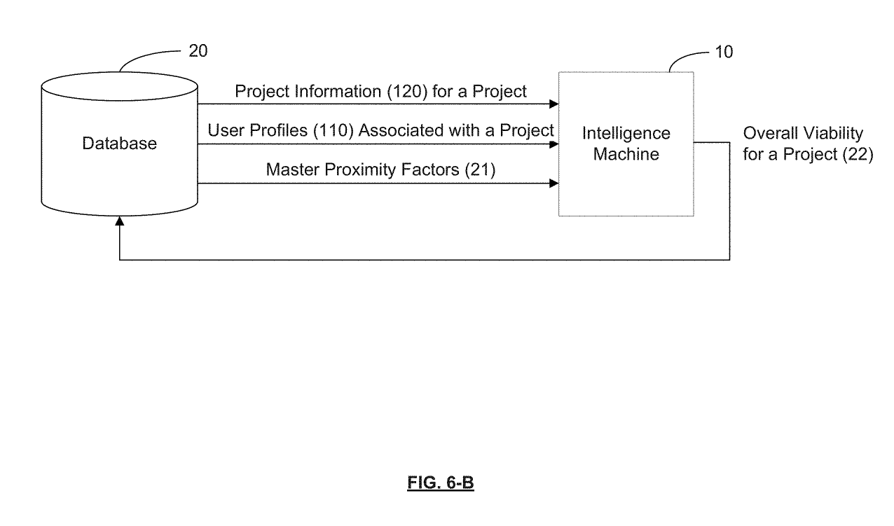

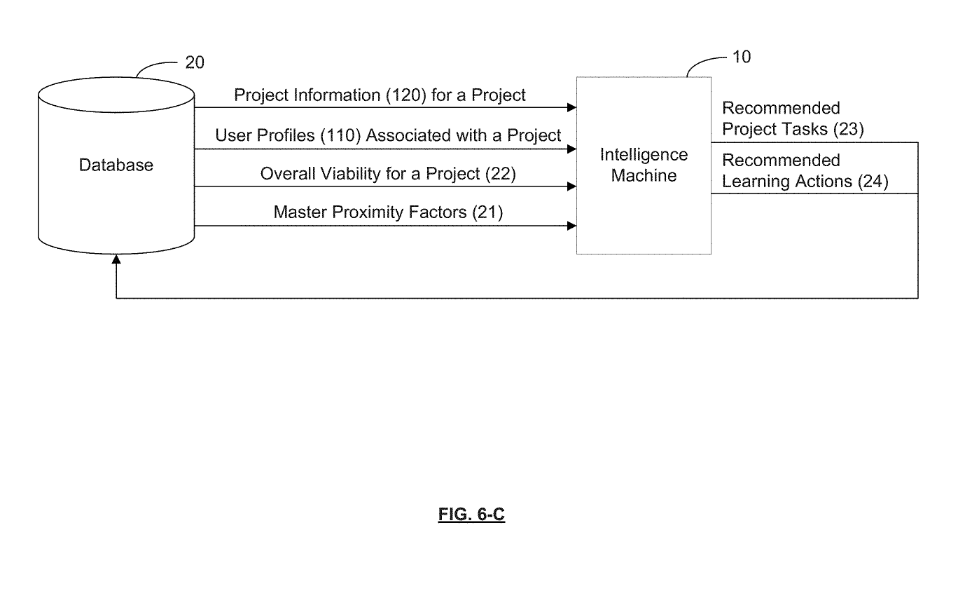

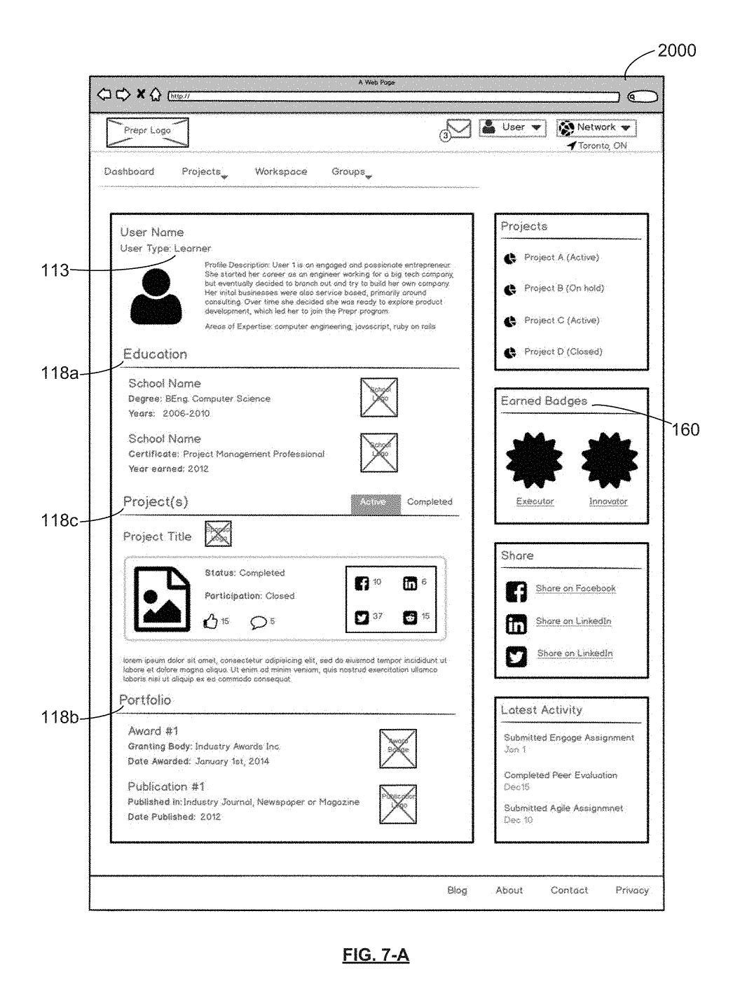

At step 1040, the intelligence machine 10 may update master proximity factors based on the plurality of user profiles 110 and the plurality of projects 120. FIG. 6-A is a block diagram showing the structure of the intelligence machine 10 for updating the master proximity factors. The intelligence machine 10 may receive user profiles 110, project information 120, and current master proximity factors 21 stored in the database 20. The intelligence machine 10 may calculate updated master proximity factors 21a. The intelligence machine 10 may store the updated master proximity factors 21a as the current master proximity factors 21 in the database 20.

At step 1050, the intelligence machine 10 may determine an overall viability 22 for a first project based on master proximity factors 21, project information 120 of the first project, and user profiles 110 associated with the first project. FIG. 6-B is a block diagram showing the determination of an overall viability 22 for a project. The intelligence machine 10 may receive project information 120 for a project, user profiles 110 of users associated with that project, and the current master proximity factors 21 stored in the database 20. Using these inputs, the intelligence machine 10 may determine an overall viability 22 for that project. The intelligence machine 10 may store the overall viability 22 for that project in the database 20. In at least one embodiment, the system 100 may determine the overall viability 22 when the primary project status is at an Entrepreneurship primary project status.

In at least one embodiment, the intelligence machine 10 may perform interim steps such determining project proximity factors for the project and determining user proximity factors for users associated with that project, and then determine an overall viability 22 based on the project proximity factors and the user proximity factors. The intelligence machine 10 may store the project proximity factors for that project and user proximity factors for the users associated with that project in the database 20. The determination of the project proximity factors, user proximity factors, and an overall viability 22 may be based on a weighted summation of a plurality of metrics.

For example, in at least one embodiment, a weighted summation of the quantitative feedback may be determined to obtain a qualitative score. In at least one embodiment, the quantitative feedback may include a plurality of segments and the weighted summation may be determined based on each segment. That is, each segment may have a corresponding weight. The keywords of the qualitative feedback may be analyzed to determine a quantitative score. The intelligence machine 10 may combine quantitative feedback scores with qualitative feedback scores to determine project proximity factors, user proximity factors, and then the overall project viability.

In at least one embodiment, a weighted summation may be based on at least one of, the sales revenue, grant revenue, number of customers, number of users, numbers of partners or types of partners, costs, number of team members, customer acquisition costs, lifetime value, and number of leads. Leads may include, but is not limited to, potential sales contacts and prospective individuals or organizations who may be interested in products or services being offered by the project.

At step 1060, the intelligence machine 10 may recommend project tasks for the first project based on the overall viability 22 determined in step 1050. FIG. 6-C is a block diagram showing recommending project tasks and learning actions. The intelligence machine 10 may receive project information 120 for a project, user profiles 110 of users associated with that project, the overall viability 22 for that project, and the current master proximity factors 21 stored in the database 20. Using these inputs, the intelligence machine 10 may identify recommended project tasks 23. The intelligence machine 10 may store the recommended project tasks 23 for that project in the database 20.

Project tasks may include securing team members and advisors for the project. In at least one embodiment, the system 100 may suggest project team members and advisors when the primary project status is at the Entrepreneurship primary project status. In at least one embodiment, the system 100 may also suggest team members and project advisors based on the project title, project objective, and industry or field information, without the overall viability 22 determined in step 1050, when the primary project status is at the Innovation primary project status. In at least one embodiment, the system 100 may also suggest team members and project advisors based on the milestones and financial information for the project, without the overall viability 22 determined in step 1050, when the primary project status is at the Project Management primary project status.

At step 1070, the intelligence machine 10 may recommend learning actions for a first user profile associated with the first project based on the first user profile and master proximity factors, and optionally, projects associated with the first user profile. As shown in FIG. 6-C, the intelligence machine 10 may use user profiles 110 of users associated with that project and the current master proximity factors 21 to identify skills gaps and recommended learning actions 24 to fill the skills gap. The intelligence machine 10 may further use project information 120 for project associated with the user profile 110 to identify recommended learning actions 24. The intelligence machine 10 may store the recommended learning actions 24 for that user in the database 20. Learning Actions relate to the systems assessment of future learning for a user to improve the user's development. Learning actions may include, but are not limited to, attending events, utilizing learning resources, or participating in learning resource groups.

In at least one embodiment, the system 100 may recommend learning actions when the primary project status is at the Entrepreneurship primary project status. In at least one embodiment, the system 100 may suggest learning actions, based on the information received when the primary project status is at the Innovation primary project status, without the overall viability 22 determined in step 1050. In at least one embodiment, the system 100 may suggest events to attend, based on the project title, project objective, and industry or field of the project, without the overall viability 22 determined in step 1050, when the primary project status is at the Innovation primary project status. In at least one embodiment, the system 100 may suggest learning actions, based on the information received when the primary project status is at the Project Management primary project status, without the overall viability 22 determined in step 1050. In at least one embodiment, the system 100 may recommend learning actions based at least one of the project type, project status, project keywords, skills gaps of team members, basic skills gaps, North American Classification System codes, and industry specific intelligence.

At step 1080, the application server 11 may display, on a graphical user interface for a client device 60 linked to the first user profile, recommended learning actions for the first user profile and recommended project tasks for projects associated with the first user profile.

In at least one embodiment, the system 100 may further determine any one or more of a market growth rate and direction, involving historic, current, and projected future; business or financial ratios; research and development ratios; and customer ratios for the project based on information received when the project status is the Entrepreneurship primary project status. In at least one embodiment, the system 100 may further generate responsibility assignment (RACI) matrices; Ishikawa-fishbone diagrams; project rollout cycles; scrum plans; product development roadmaps; manage milestones, work packages, and tasks; and collect feedback and review when the project status is the Project Management primary project status. In at least one embodiment, the system 100 may further summarize project metrics, such as financial and schedule data, when the project status is the Completed project status.

Numerous specific details are set forth herein in order to provide a thorough understanding of the example embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A computer-implemented method of providing hybrid innovation and learning management, the method comprising:
in a system configured to host a webpage, the system comprising at least one processor and a memory, storing, on a storage device, a plurality of user profiles, a plurality of projects, and a plurality of pre-defined project statuses, each project being associated with at least one user profile, each user profile comprising user information received from a client device linked to that user profile, each project comprising project information received from a client device linked to a user profile associated with that project, project information comprising at least one project status indicator corresponding to a pre-defined project status;
maintaining, on the storage device, project information for each project;
maintaining, on the storage device, user information for each user profile;
updating master proximity factors based on the plurality of user profiles and the plurality of project information;
determining an overall viability for a first project based on project information of the first project, user profiles associated with the first project, and master proximity factors;
recommending project tasks for the first project based on the determined overall viability;
recommending learning actions for a first user profile associated with the first project based on the first user profile and master proximity factors and optionally, projects associated with the first user profile; and
displaying, on a graphical user interface for a client device linked to the first user profile, recommended learning actions for the first user profile and recommended project tasks for projects associated with the first user profile.

2. The method of claim 1, wherein:
the step of recommending learning actions for a first user profile associated with the first project further comprises recommending learning actions based on the overall viability for the first project.

3. The method of claim 1, wherein:
the step of storing, on a storage device, a plurality of user profiles, a plurality of projects, and a plurality of pre-defined project statuses further comprises storing, on the storage device, a plurality of learning programs; and
if the first user profile is associated with a first learning program, the step of recommending learning actions for a first user profile associated with the first project further comprises recommending learning actions based on the first learning program.

4. The method of claim 1, wherein:
the step of storing, on a storage device, a plurality of user profiles, a plurality of projects, and a plurality of pre-defined project statuses further comprises:
receiving from a client device, a user profile request and user information for a requested user profile;
in response to receiving the user profile request and user information, creating the requested user profile based on the user information;
receiving, from a client device linked to a user profile, a project request and project information for a requested project; and
in response to receiving the project request and project information,
creating the requested project based on the project information; and
associating the requested project with the user profile.

5. The method of claim 4, wherein:
the step of storing, on a storage device, a plurality of user profiles, a plurality of projects, and a plurality of pre-defined project statuses further comprises:
storing, on the storage device, a plurality of challenges; and
displaying, on a graphical user interface for the client device linked to a user profile, at least one of the plurality of challenges; and
the step of receiving, from a client device linked to a user profile, a project request and project information for a requested project further comprises:
receiving, from the client device linked to a user profile, a selected challenge, the selected challenge corresponding to at least one of the plurality of challenges; and
associating the requested project with the selected challenge.

6. The method of claim 4, wherein:
the step of storing, on a storage device, a plurality of user profiles, a plurality of projects, and a plurality of pre-defined project statuses further comprises:
for each user profile,
displaying, on a graphical user interface for a client device linked to that user profile, project association requests, each project association request corresponding to a project that that user profile is not associated with; and
in response to receiving, from the client device linked to that user profile, a selection of a project association request, associating the user profile with the project corresponding to the project association request.

7. The method of claim 6, wherein the project association requests displayed on the graphical user interface are based on user information of that user profile.

8. The method of claim 6, wherein:
the step of storing, on a storage device, a plurality of user profiles, a plurality of projects, and a plurality of pre-defined project statuses further comprises:
storing a plurality of pre-defined user roles;
for each association of a user profile and a project, storing a user role indicator corresponding to a pre-defined user role.

9. The method of claim 4, wherein:
each project further comprises project feedback received from a client device linked to a user profile; and
the step of storing, on a storage device, a plurality of user profiles, a plurality of projects, and a plurality of pre-defined project statuses further comprises:
receiving project feedback related to a project from a client device linked to a user profile; and
in response to receiving the project feedback,
storing, on the storage device, the project feedback for that project; and
displaying, on a graphical user interface for a client device linked to a user profile associated with the project, the project feedback.

10. The method of claim 1, wherein:
the step of maintaining, on the storage device, project information for each project further comprises:
displaying, on a graphical user interface for a client device linked to a user profile associated with that project, the plurality of pre-defined project statuses;
receiving from a client device linked to a user profile associated with that project, a selection of a pre-defined project status; and
in response to receiving a selection of a pre-defined project status, storing a project status indicator corresponding to the selection.

11. The method of claim 1, wherein:
the step of maintaining, on the storage device, project information for each project further comprises:
determining a geographical location of the client device from which project information is received; and
storing, on the storage device, the geographical location with the received project information; and
the step of maintaining, on the storage device, user information for each user profile further comprises:
determining a geographical location of the client device from which user information is received; and
storing, on the storage device, the geographical location with the received user information.

12. The method of claim 11, wherein the step of determining an overall viability for a first project is further based on the geographical location stored with the project information.

13. The method of claim 11, wherein:
the step of maintaining, on the storage device, user information for each user profile further comprises:
for each user profile:
displaying, on a graphical user interface for a client device linked to that user profile, a plurality of learning actions;
receiving, from a client device linked to that user profile, a selection of a learning action; and
in response to receiving a selection of a learning action, updating user of that user profile based on the selection of a learning action.

14. The method of claim 13, wherein:
the learning action comprises learning resources;
the step of displaying, on a graphical user interface for a client device linked to that user profile, a plurality of learning actions further comprises storing, on the storage device, at least one of learning resources and links to learning resources; and
the step of updating user of that user profile based on the selection of a learning action further comprises at least one of providing the learning resources at that client device and accessing links to the learning resources at that client device.

15. The method of claim 13, wherein:
the learning actions comprises event attendance;
the step of displaying, on a graphical user interface for a client device linked to that user profile, a plurality of learning actions further comprises storing, on the storage device, a plurality of events, each event comprising event location information received from a client device linked to a user profile;
the step of receiving, from a client device linked to that user profile, a selection of a learning action further comprises determining a geographical location of the client device from which the selection of a learning action is received; and
the step of updating user of that user profile based on the selection of a learning action further comprises determining that the geographical location of the client device from which the selection of a learning action is received corresponds to the event location information.

16. The method of claim 1, wherein the step of updating master proximity factors comprises:
storing, on the storage device, master proximity factors; and
for each project,
assessing project performance based on the project information for that project;
determining project proximity factors based on the project performance and the project information for that project;
updating the master proximity factors based on project proximity factors for that project; and
for each user profile associated with that project,
assessing user development based on user information for that user profile;
determining user proximity factors based on the user development and the user information; and
updating the master proximity factors based on the user proximity factors.

17. The method of claim 16, wherein the step of determining an overall viability for a first project comprises:
determining current project proximities based on project information of the first project;
determining current user proximities based on user information of user profiles associated with the first project; and
determining the overall viability for the first project based on the current project proximities, current user proximities, and the master proximity factors.

18. The method of claim 17, wherein:
for each project, the step of determining project proximity factors comprises assessing the at least one project status indicator for that project in relation to the plurality of pre-defined project statuses; and
the step of determining current project proximities comprises assessing the at least one project status indicator of the first project in relation to the plurality of pre-defined project statuses.

19. The method of claim 17, wherein:
the overall viability comprises at least one of market viability and execution viability,
market viability being based on current project proximities and master proximity factors, and
execution viability being based on current user proximities of user profiles associated with that project and master proximity factors.

20. The method of claim 16, wherein the step of determining an overall viability for a first project further comprises:
accessing a network to obtain third-party information not stored on the storage device and relevant to the project information; and
determining the overall viability for the first project based on the third-party information.

21. The method of claim 1, wherein the step of recommending project tasks for the first project comprises:
determining current project proximities that are non-compliant with master proximity factors;
identifying project tasks that improve non-compliant current project proximities; and
determining whether identified project tasks are applicable to the first project.

22. The method of claim 1, wherein the step of recommending learning actions for a first user profile associated with the first project comprises:
determining current user proximities that are non-compliant with master proximity factors;
identifying learning actions that improve non-compliant current user proximities; and
determining whether identified learning actions are applicable to the first user profile.

23. A non-transitory computer-readable storage medium having instructions stored thereon for execution by one or more processors for implementing a method comprising:
in a system configured to host a webpage, the system comprising at least one processor and a memory, storing, on a storage device, a plurality of user profiles, a plurality of projects, and a plurality of pre-defined project statuses, each project being associated with at least one user profile, each user profile comprising user information received from a client device linked to that user profile, each project comprising project information received from a client device linked to a user profile associated with that project, project information comprising at least one project status indicator corresponding to a pre-defined project status;
maintaining, on the storage device, project information for each project;
maintaining, on the storage device, user information for each user profile;
updating master proximity factors based on the plurality of user profiles and the plurality of project information;
determining an overall viability for a first project based on project information of the first project, user profiles associated with the first project, and master proximity factors;
recommending project tasks for the first project based on the determined overall viability;
recommending learning actions for a first user profile associated with the first project based on the first user profile and master proximity factors and optionally, projects associated with the first user profile; and
displaying, on a graphical user interface for a client device linked to the first user profile, recommended learning actions for the first user profile and recommended project tasks for projects associated with the first user profile.

24. A system comprising:
a processor; and
a non-transitory computer-readable storage medium having instructions stored thereon for implementing the method of claim 1.
